(19) United States
(12) Patent Application Publication
(10) Pub. No.: US 2026/0106557 A1
(43) Pub. Date: Apr. 16, 2026

(54) MOTOR CONTROL DEVICE, MOTOR MODULE, MOTOR CONTROL PROGRAM, AND MOTOR CONTROL METHOD

(71) Applicant: NIDEC CORPORATION, Kyoto (JP)

(72) Inventors: Shota HASEGAWA, Kyoto (JP); Kotaro KATAOKA, Kyoto (JP)

(21) Appl. No.: 19/116,366

(22) PCT Filed: Sep. 25, 2023
(86) PCT No.: PCT/JP2023/034689

§ 371 Date: Mar. 28, 2025

(30) Foreign Application Priority Data
Sep. 30, 2022 (JP) 2022-158799

(51) Int. Cl. H02M 7/5395; H02M 7/5387; H02P 27/08

(52) U.S. Cl. CPC H02M 7/5395; H02M 7/53873; H02P 27/085

(57) ABSTRACT

A motor controller includes: an inverter circuit including an upper arm and a lower arm for each of three phases; a conduction controller controlling conduction of the upper and lower arms of each of the three phases; and a determination unit determining switching from (i) a two-phase modulation method in which two of the three phases are PWM-controlled and the remaining one phase is a fixed phase in which any one of the upper and lower arms is always turned on to (ii) a 120-degree energization method in which two of the three phases are energization phases and the remaining one phase is a non-energization phase. The conduction controller includes a switching compensation unit causing the upper and lower arms in each of the two energization phases to be identical in an ON-OFF state before and after switching from the two-phase modulation method to the 120-degree energization method.

### CROSS-REFERENCE TO RELATED APPLICATIONS

This is the U.S. national stage of application No. PCT/JP2023/034689, filed on Sep. 25, 2023, and priority under 35 U.S.C. § 119(a) and 35 U.S.C. § 365(b) is claimed from Japanese Patent Application No. 2022-158799, filed on Sep. 30, 2022.

### FIELD OF THE INVENTION

The present disclosure relates to a motor control device, a motor module, a motor control program, and a motor control method.

### BACKGROUND

Examples of a conventionally known technique for controlling a motor include a 120-degree energization method in which two phases of three phases are energization phases and the remaining one phase is non-energization phases, and a two-phase modulation method in which two phases of three phases are pulse width modulation (PWM) phases and the remaining one phase is a fixed phase.

Switching between the 120-degree energization method and the two-phase modulation method that is vector controlled depending on a load condition and a drive condition of an electric motor enables highly efficient drive suitable for the load condition and the drive condition of the electric motor. The switching further enables the drive of the electric motor to be stabilized in a wide range of rotational speed.

Adding a dead time at the time of switching from the two-phase modulation method to the 120-degree energization method lowers motor output, so that a transition without the dead time is desirable. Unfortunately, the transition causes upper and lower arms of the same phase in an inverter circuit to be simultaneously turned on, and thus these upper and lower arms may be short-circuited.

### SUMMARY

A motor control device according to an aspect of the present disclosure includes an inverter circuit, a conduction controller, and a determination unit. The inverter circuit includes an upper arm and a lower arm for each of three phases.

The conduction controller controls conduction of the upper arm and the lower arm of each of the three phases in the inverter circuit. The determination unit determines switching from a two-phase modulation method in which two phases of the three phases serve as PWM phases that are PWM-controlled and the remaining one phase serve as a fixed phase in which any one of the upper arm and the lower arm is always turned on to a 120-degree energization method in which two phases of the three phases serve as energization phases and the remaining one phase serve as a non-energization phase. The conduction controller includes a switching compensation unit that causes the upper arm and the lower arm in each of the two energization phases to be identical in an ON-OFF state before and after switching from the two-phase modulation method to the 120-degree energization method, the switching being determined by the determination unit.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram illustrating an example of a configuration of a motor module according to an embodiment;

FIG. 2 is a diagram illustrating an example of a configuration of an inverter circuit in a motor control device according to a first embodiment;

FIG. 3 is a diagram illustrating a state of each phase in each section of a 120-degree energization method in a motor control device according to the embodiment;

FIG. 4 is a diagram illustrating a state of each phase in each section of a Min type performed by a motor control device according to the embodiment;

FIG. 5 is a diagram illustrating a state of each phase in each section of a Max type performed by a motor control device according to the embodiment;

FIG. 6 is a diagram illustrating a state of each phase in each section of a Min-Max type performed by a motor control device according to the embodiment;

FIG. 7A is a diagram illustrating an example of control in a case where a conduction type used in a motor control device according to the embodiment is a valley ON type;

FIG. 7B is a diagram illustrating an example of control in a case where a conduction type used in a motor control device according to the embodiment is a peak ON type;

FIG. 8A is a diagram illustrating an example of control of an inverter circuit 10 by a 120-degree energization method of a High-side PWM control type and a valley ON type in a motor control device according to the embodiment;

FIG. 8B is a diagram illustrating an example of control of the inverter circuit 10 by a 120-degree energization method of a High-side PWM control type and a peak ON type in a motor control device according to the embodiment;

FIG. 9A is a diagram illustrating an example of control of the inverter circuit 10 by a 120-degree energization method of a Low-side PWM control type and a valley ON type in a motor control device according to the embodiment;

FIG. 9B is a diagram illustrating an example of control of the inverter circuit 10 by a 120-degree energization method of a Low-side PWM control type and a peak ON type in a motor control device according to the embodiment;

FIG. 10A is a diagram illustrating an example of control of the inverter circuit 10 by a 120-degree energization method of a Both-side PWM control type and a valley ON type in a motor control device according to the embodiment;

FIG. 10B is a diagram illustrating an example of control of the inverter circuit 10 by a 120-degree energization method of a Both-side PWM control type and a peak ON type in a motor control device according to the embodiment;

FIG. 11A is a diagram illustrating an example of control of an inverter circuit by in-phase control in a motor control device according to the embodiment;

FIG. 11B is a diagram illustrating an example of control of an inverter circuit by reverse-phase control in a motor control device according to the embodiment;

FIG. 12A is a diagram illustrating an example of a conduction type of a two-phase modulation method of a Min type in a motor control device 1 according to the embodiment;

FIG. 12B is a diagram illustrating an example of a conduction type of a two-phase modulation method of a Min type in the motor control device 1 according to the embodiment;

FIG. 13A is a diagram illustrating an example of a conduction type of a two-phase modulation method of a Max type in the motor control device 1 according to the embodiment;

FIG. 13B is a diagram illustrating an example of a conduction type of a two-phase modulation method of a Max type in the motor control device 1 according to the embodiment;

FIG. 14 is a diagram illustrating an example of a configuration of a conduction switching unit 40 in the motor control device 1 according to the embodiment;

FIG. 15A is a diagram illustrating an example of switching from a two-phase modulation method to a 120-degree energization method when switching compensation is not performed in the motor control device 1 according to the embodiment;

FIG. 15B is a diagram illustrating an example of switching from the two-phase modulation method to the 120-degree energization method when switching compensation is not performed in the motor control device 1 according to the embodiment;

FIG. 16A is a diagram illustrating an example of switching from a two-phase modulation method to a 120-degree energization method when switching compensation is performed in the motor control device 1 according to the embodiment;

FIG. 16B is a diagram illustrating an example of the switching from the two-phase modulation method to the 120-degree energization method when the switching compensation is performed in the motor control device 1 according to the embodiment;

FIG. 16C is a diagram illustrating an example of the switching from the two-phase modulation method to the 120-degree energization method when the switching compensation is performed in the motor control device 1 according to the embodiment;

FIG. 16D is a diagram illustrating an example of the switching from the two-phase modulation method to the 120-degree energization method when the switching compensation is performed in the motor control device 1 according to the embodiment;

FIG. 17 is a diagram illustrating an example of motor control processing according to the embodiment according to the embodiment;

FIG. 18 is a diagram illustrating an example of switching compensation processing according to the embodiment;

FIG. 19 is a diagram illustrating an example of a combination in which a short circuit does not occur in upper and lower arms during transition in in-phase control of a two-phase modulation method;

FIG. 20 is a diagram illustrating an example of the combination in which a short circuit does not occur in the upper and lower arms during the transition in the in-phase control of the two-phase modulation method;

FIG. 21A is a diagram illustrating an example of switching in a two-phase modulation method (Min type, PWM phase peak ON type of in-phase control);

FIG. 21B is a diagram illustrating an example of the switching in the two-phase modulation method (Min type, PWM phase peak ON type of in-phase control);

FIG. 21C is a diagram illustrating an example of the switching in the two-phase modulation method (Min type, PWM phase peak ON type of in-phase control);

FIG. 22A is a diagram illustrating an example of switching in a two-phase modulation method (Min type, PWM phase valley ON type of in-phase control);

FIG. 22B is a diagram illustrating an example of the switching in the two-phase modulation method (Min type, PWM phase valley ON type of in-phase control);

FIG. 22C is a diagram illustrating an example of the switching in the two-phase modulation method (Min type, PWM phase valley ON type of in-phase control);

FIG. 23A is a diagram illustrating an example of switching in a two-phase modulation method (Max type, PWM phase peak ON type of in-phase control);

FIG. 23B is a diagram illustrating an example of the switching in the two-phase modulation method (Max type, PWM phase peak ON type of in-phase control);

FIG. 23C is a diagram illustrating an example of the switching in the two-phase modulation method (Max type, PWM phase peak ON type of in-phase control);

FIG. 24A is a diagram illustrating an example of switching in a two-phase modulation method (Max type, PWM phase valley ON type of in-phase control);

FIG. 24B is a diagram illustrating an example of the switching in the two-phase modulation method (Max type, PWM phase valley ON type of in-phase control);

FIG. 24C is a diagram illustrating an example of the switching in the two-phase modulation method (Max type, PWM phase valley ON type of in-phase control);

FIG. 25 is a diagram illustrating an example of a combination in which a short circuit does not occur in upper and lower arms during transition in reverse phase control of a two-phase modulation method;

FIG. 26 is a diagram illustrating an example of the combination in which a short circuit does not occur in the upper and lower arms during the transition in the reverse phase control of the two-phase modulation method;

FIG. 27A is a diagram illustrating an example of switching in a two-phase modulation method (Min type, intermediate phase peak ON type of in-phase control);

FIG. 27B is a diagram illustrating an example of the switching in the two-phase modulation method (Min type, intermediate phase peak ON type of in-phase control);

FIG. 27C is a diagram illustrating an example of the switching in the two-phase modulation method (Min type, intermediate phase peak ON type of in-phase control);

FIG. 28A is a diagram illustrating an example of switching in a two-phase modulation method (Min type, intermediate phase peak ON type of reverse phase control);

FIG. 28B is a diagram illustrating an example of the switching in the two-phase modulation method (Min type, intermediate phase peak ON type of reverse phase control);

FIG. 28C is a diagram illustrating an example of the switching in the two-phase modulation method (Min type, intermediate phase peak ON type of reverse phase control);

FIG. 29A is a diagram illustrating an example of switching in a two-phase modulation method (Max type, intermediate phase peak ON type of reverse phase control);

FIG. 29B is a diagram illustrating an example of the switching in the two-phase modulation method (Max type, intermediate phase peak ON type of reverse phase control);

FIG. 29C is a diagram illustrating an example of the switching in the two-phase modulation method (Max type, intermediate phase peak ON type of reverse phase control);

FIG. 30A is a diagram illustrating an example of switching in a two-phase modulation method (Max type, intermediate phase valley ON type of reverse phase control);

FIG. 30B is a diagram illustrating an example of the switching in the two-phase modulation method (Max type, intermediate phase valley ON type of reverse phase control);

FIG. 30C is a diagram illustrating an example of the switching in the two-phase modulation method (Max type, intermediate phase valley ON type of reverse phase control); and

FIG. 31 is a diagram illustrating an example of a hardware configuration of a controller 30 of the motor control device 1 according to the embodiment.

### DETAILED DESCRIPTION

Hereinafter, embodiments of the present disclosure will be described in detail with reference to the drawings. The embodiments will be described in the following order. Each of the embodiments below includes an identical part that is denoted by an identical reference numeral, and duplicated description will not be described. The order is as follows: 1. Motor module, 2. Motor control device, 3. Switching from two-phase modulation method to 120-degree energization method, and 4. Hardware configuration.

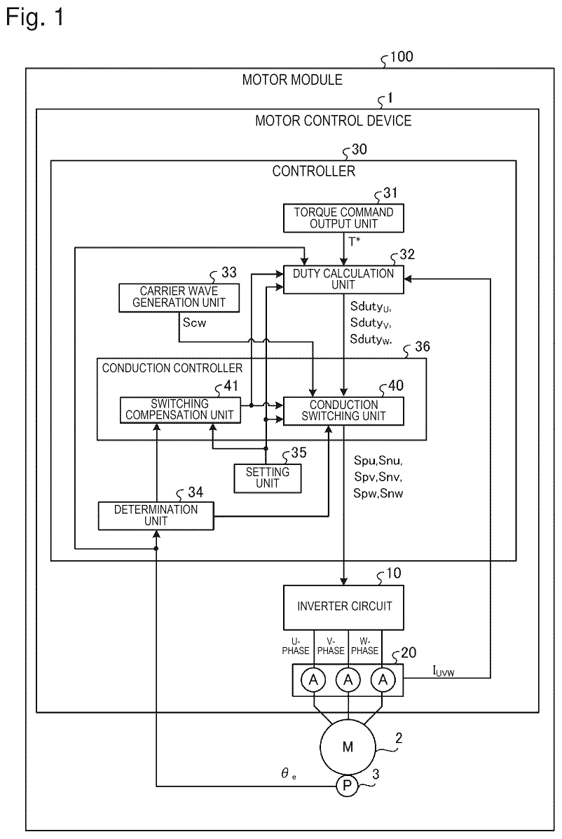

FIG. 1 is a diagram illustrating an example of a configuration of a motor module according to an embodiment. As illustrated in FIG. 1, a motor module 100 according to the embodiment includes a motor control device 1, a motor 2 controlled by the motor control device 1, and a position detection device 3 that detects a position θₑ of a rotor of the motor 2. The motor 2 is a three-phase motor.

The position detection device 3 detects the position θₑ of the rotor of the motor 2 and outputs the detected position θₑ to the motor control device 1. The position θₑ is an electrical angle of the rotor of the motor 2. Although the position detection device 3 is a magnetic sensor using a Hall element or the like, for example, it may be a resolver. The position detection device 3 may be an optical encoder that detects a position θₘ of the rotor of the motor 2. The position θₘ of the rotor of the motor 2 is a mechanical angle of the rotor of the motor 2. The magnetic sensor or the resolver may be configured to detect the position θₘ of the rotor of the motor 2. The motor control device 1 also may have a function of performing position sensorless control. For this configuration, the motor module 100 may not be provided with the position detection device 3.

The motor control device 1 drives the motor 2 by selectively using a 120-degree energization method and a two-phase modulation method. The 120-degree energization method used by the motor control device 1 uses three phases with two phases at least one of which serves as an energization phase that is PWM-controlled, and with the remaining one phase serving as a non-energization phase. Then, the two-phase modulation method used by the motor control device 1 uses three phases with two phases serving as PWM phases that are PWM-controlled, and with the remaining one phase serving as a fixed phase in which any one of an upper arm and a lower arm to be described later is always turned on.

As illustrated in FIG. 1, the motor control device 1 includes an inverter circuit 10, a current sensor 20, and a controller 30. Hereinafter, the inverter circuit 10, the current sensor 20, and the controller 30 will be described in this order.

The inverter circuit 10 is configured to drive the motor 2. Details of the configuration of the inverter circuit 10 will be described later.

The current sensor 20 detects a three-phase current value I_{UVW}, which is an instantaneous value of a three-phase current flowing from the inverter circuit 10 to the motor 2, and outputs the detected three-phase current value I_{UVW} to the controller 30. The three-phase current value I_{UVW} includes an instantaneous value of a U-phase current, an instantaneous value of a V-phase current, and an instantaneous value of a W-phase current.

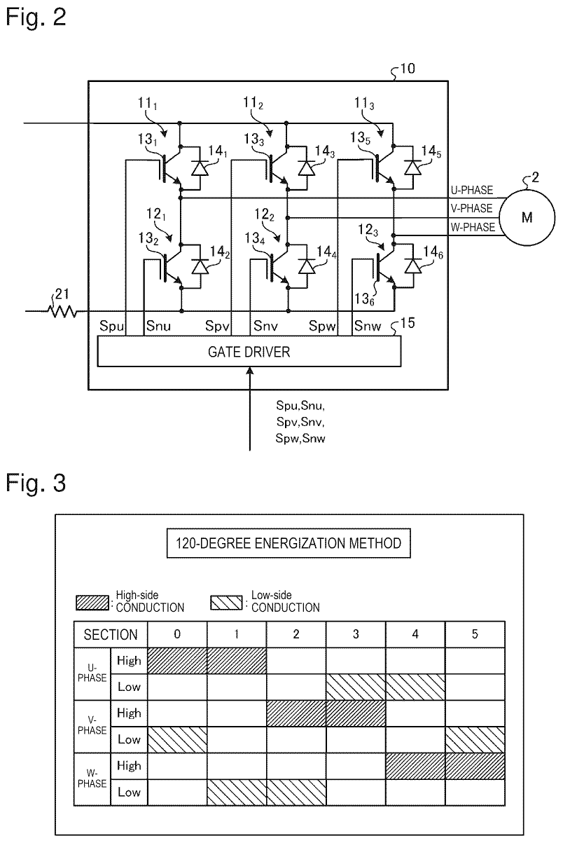

Although the current sensor 20 uses a Hall element, for example, it is not limited to such an example. It may use a current transformer called a current transformer (CT) or a current sensor using a shunt resistor. When the current sensor 20 is a shunt resistor, the current sensor 20 includes a shunt resistor 21 illustrated in FIG. 2 instead of the position illustrated in FIG. 1, for example. The shunt resistor may be provided between a lower arm 12 of each of a U-phase, a V-phase, and a W-phase and a DC bus on a negative side.

As illustrated in FIG. 1, the controller 30 includes a torque command output unit 31, a duty calculation unit 32, a carrier wave generation unit 33, a determination unit 34, a setting unit 35, and a conduction controller 36.

The torque command output unit 31 outputs a torque command T*. The torque command T* is an example of target output torque. For example, the torque command output unit 31 may be configured to generate the torque command T* to allow speed of the motor 2 to match a speed command, and output the generated torque command T*.

The duty calculation unit 32 calculates duty values Sduty_{U}, Sduty_{V}, and Sduty_{W} of the U-phase, the V-phase, and the W-phase based on the torque command T* output from the torque command output unit 31, the three-phase current values I_{UVW} output from the current sensor 20, and the position θe detected by the position detection device 3. For example, the duty calculation unit 32 calculates the duty values Sduty_{U}, Sduty_{V}, and Sduty_{W} of the U-phase, the V-phase, and the W-phase based on the torque command T*, the three-phase current value I_{UVW}, and the position θₑ to cause the motor 2 to output torque according to the torque command T*. The duty calculation unit 32 outputs the calculated duty values Sduty_{U}, Sduty_{V}, and Sduty_{W} to the conduction controller 36.

When an energization method is switched from the 120-degree energization method to the two-phase modulation method, the duty calculation unit 32 generates duty values Sduty_{U}, Sduty_{V}, and Sduty_{W} by vector control. For example, the duty calculation unit 32 converts the three-phase current value I_{UVW} into a dq-axis current value that is a value in a dq coordinate system, and generates the duty values Sduty_{U}, Sduty_{V}, and Sduty_{W} to reduce a difference between the dq-axis current value and a dq-axis current command according to the torque command T*.

For example, the duty calculation unit 32 switches the duty values Sduty_{U}, Sduty_{V}, and Sduty_{W} to be output from the duty values Sduty_{U}, Sduty_{V}, and Sduty_{W} for the 120-degree energization method to the duty values Sduty_{U}, Sduty_{V}, and Sduty_{W} for the two-phase modulation method at switching timing determined by the conduction controller 36. When the duty values Sduty_{U}, Sduty_{V}, and Sduty_{W} are each described without being individually distinguished, the duty values may be referred to below as a duty value Sduty. Based on the duty value Sduty, a compare value Scomp to be described later is calculated.

For example, the carrier wave generation unit 33 generates a carrier wave Scw in a triangular wave shape, and outputs the generated carrier wave Scw in a triangular wave shape to the conduction controller 36. The carrier wave generation unit 33 can also output a carrier wave Scw in a sawtooth wave shape instead of the carrier wave Scw in a triangular wave shape.

The determination unit 34 determines a section corresponding to an electrical angle of the motor 2 among six sections 0 to 5 acquired by dividing the electrical angle of the motor 2 into ranges different from each other. The determination unit 34 outputs section information indicating the determined section to the conduction controller 36.

The section 0 has an electrical angle in a range of 30° or more and less than 90°, the section 1 has an electrical angle in a range of 90° or more and less than 150°, and the section 2 has an electrical angle in a range of 150° or more and less than 210°. The section 3 has an electrical angle in a range of 210° or more and less than 270°, the section 4 has an electrical angle in a range of 270° or more and less than 330°, and the section 5 has an electrical angle in a range of 0° or more and less than 30° and a range of 330° or more and less than 360°.

The determination unit 34 determines the section based on the position θₑ of the rotor of the motor 2. When the position detection device 3 outputs the position θₘ of the rotor of the motor 2, the position θₘ output from the position detection device 3 is multiplied by a pole logarithm P of the motor 2 to calculate position θₑ=(θₘ×P) mod 360 of the rotor of motor 2. Here, the mod is an operation of returning a remainder after a numerical value is divided.

As will be described later, the determination unit 34 further determines switching from the two-phase modulation method to the 120-degree energization method. Details of the 120-degree energization method and the two-phase modulation method will be described later.

The setting unit 35 stores setting information. The setting information includes 120-degree energization information and two-phase modulation information. The setting unit 35 outputs the setting information to the duty calculation unit 32, the conduction controller 36, and the like. Although the setting information is set in the setting unit 35 by a manufacturer of the motor control device 1, it may be set in the setting unit 35 by a user of the motor control device 1. The 120-degree energization information is on the 120-degree energization method, and includes conduction type information and control type information. The two-phase modulation information includes control type information. Details of the 120-degree energization information and the 2-phase modulation information will be described later.

The conduction controller 36 includes a conduction switching unit 40 that generates gate signals Spu, Snu, Spv, Snv, Spw, and Snw, and a switching compensation unit 41 that performs switching compensation processing.

The conduction switching unit 40 generates the gate signals Spu, Snu, Spv, Snv, Spw, and Snw based on the duty value Sduty output from the duty calculation unit 32, the carrier wave Scw output from the carrier wave generation unit 33, the information output from the determination unit 34, the setting information output from the setting unit 35, and the information output from the switching compensation unit 41. Details of operation of the conduction switching unit 40 will be described later.

The switching compensation unit 41 is configured to compensate for switching from the two-phase modulation method to the 120-degree energization method in a state without dead time. Here, the dead time is a period in which the upper and lower arms are simultaneously turned off at the time of switching. When the two-phase modulation method is switched to the 120-degree energization method, two PWM phases and a fixed phase of the two-phase modulation method need to be assigned to two energization phases and a non-energization phase of the 120-degree energization method, respectively. At this time, periods of ON states of the upper and lower arms may overlap each other depending on ON-OFF states of the upper and lower arms of each phase. During a period in which the upper and lower arms are each in the ON state, the upper and lower arms are short-circuited (so-called arm short-circuited) to cause a large current to flow.

Thus, providing a dead time at the time of switching enables preventing a short circuit between the upper and lower arms. However, power is not supplied to the motor 2 during the dead time, so that output of the motor 2 is reduced by providing the dead time. To address such a problem, the switching compensation unit 41 is disposed. When a method switching request is output from the determination unit 34, the switching compensation unit 41 performs control to cause the upper arm and the lower arm in each of the two energization phases of the 120-degree energization method to be identical in an ON-OFF state before and after the switching from the two-phase modulation method to the 120-degree energization method. This control enables the periods of the ON states of the upper and lower arms to be prevented from overlapping each other. Details of operation of the switching compensation unit 41 will be described later.

FIG. 2 is a diagram illustrating an example of a configuration of the inverter circuit 10 in the motor control device 1 according to a first embodiment. The inverter circuit 10 converts DC power into AC power and outputs the converted AC power to the motor 2. For example, the inverter circuit 10 is connected to a converter circuit (not illustrated) that converts AC power supplied from an AC power supply (not illustrated) into DC power to convert the DC power output from the converter circuit into AC power, and outputs the converted AC power to the motor 2. Alternatively, the inverter circuit 10 may be connected to a DC power supply (not illustrated) without using a converter circuit.

As illustrated in FIG. 2, the inverter circuit 10 includes upper arms 11₁, 11₂, and 11₃, lower arms 12₁, 12₂, and 12₃, and a gate driver 15. The inverter circuit 10 is provided with filters (not illustrated) each including a coil and a capacitor in the U-phase, the V-phase, and the W-phase. Alternatively, the inverter circuit 10 may have a configuration in which no filter is provided.

The upper arm 111 and the lower arm 121 constitute a U-phase half bridge circuit, the upper arm 11₂ and the lower arm 12₂ constitute a V-phase half bridge circuit, and the upper arm 11₃ and the W-phase lower arm 12₃ constitute a W-phase half bridge circuit.

The upper arm 11₁ includes a switching element 13₁ and a diode 14₁ connected in anti-parallel to the switching element 13₁. The lower arm 12₁ includes a switching element 13₂ and a diode 14₂ connected in anti-parallel to the switching element 13₂. The upper arm 11₂ includes a switching element 13₃ and a diode 14₃ connected in anti-parallel to the switching element 13₃. The lower arm 12₂ includes a switching element 13₄ and a diode 14₄ connected in anti-parallel to the switching element 13₄. The upper arm 11₃ includes a switching element 13₅ and a diode 14₅ connected in anti-parallel to the switching element 13₅. The lower arm 12₃ includes a switching element 13₆ and a diode 14₆ connected in anti-parallel to the switching element 13₆.

Each of the switching elements 13₁, 13₂, 13₃, 13₄, 13₅, and 13₆ is a switching element such as an insulated gate bipolar transistor (IGBT) or a metal oxide semiconductor field effect transistor (MOSFET), for example. Each of the switching elements 13₁, 13₂, 13₃, 13₄, 13₅, and 13₆ is a switching element made of a silicon-based material or a switching element composed of a wide bandgap semiconductor, for example. The wide bandgap semiconductor is made of silicon carbide (SiC), gallium nitride (GaN), gallium oxide (Ga₂O₃), or diamond, for example.

The gate driver 15 amplifies the gate signals Spu, Spv, Spw, Snu, Snv, and Snw to be described later output from the controller 30. Then, the gate driver 15 outputs the amplified gate signals Spu, Spv, Spw, Snu, Snv, and Snw to gates of the upper arms 11₁, 11₂, and 11₃, and the lower arms 12₁, 12₂, and 12₃, respectively.

Specifically, the gate driver 15 outputs the amplified gate signal Spu to the upper arm 11₁ of the U-phase, and outputs the amplified gate signal Snu to the lower arm 12₁ of the U-phase. The gate driver 15 also outputs the amplified gate signal Spv to the upper arm 11₂ of the V-phase, and outputs the amplified gate signal Snv to the lower arm 12₂ of the V-phase.

The gate driver 15 also outputs the amplified gate signal Spw to the upper arm 11₃ of the W-phase, and outputs the amplified gate signal Snw to the lower arm 12₃ of the W-phase.

When the upper arms 11₁, 11₂, and 11₃ are each described below without being individually distinguished, they may be referred to as an upper arm 11. When the lower arms 12₁, 12₂, and 12₃ each described below without being individually distinguished, they may be referred to as a lower arm 12. When the gate signals Spu, Spv, and Spw are each described below without being individually distinguished, they may be referred to as a gate signal Sp. When the gate signals Snu, Snv, and Snw are each described below without being individually distinguished, they may be referred to as a gate signal Sn.

FIG. 3 is a diagram illustrating a state of each phase in each section of the 120-degree energization method in the motor control device 1 according to the embodiment. As illustrated in FIG. 3, the 120-degree energization method uses the six sections from the section 0 to the section 5 that are different from each other in a combination of a High-side conduction phase, a Low-side conduction phase, and a non-energization phase in the three phases. Each of the High-side conduction phase and the Low-side conduction phase serves as an energization phase, and the High-side conduction phase has a higher voltage than the Low-side conduction phase.

The High-side conduction phase is configured to cause a current to positively flow in a positive direction on one cycle average of a PWM when the upper arm 11 is PWM-controlled or fixed to the ON state. The Low-side conduction phase is configured to cause a current to positively flow in a negative direction on the one cycle average of the PWM when the lower arm 12 is PWM-controlled or fixed to the ON state. The non-energization phase is configured to cause a current not to positively flow when both the upper arm 11 and the lower arm 12 are each fixed to the OFF state.

The section 0 includes the U-phase serving as the High-side conduction phase, the V-phase serving as the Low-side conduction phase, and the W-phase serving as the non-energization phase. The section 1 includes the U-phase serving as the High-side conduction phase, the W-phase serving as the Low-side conduction phase, and the V-phase serving as the non-energization phase. The section 2 includes the V-phase serving as the High-side conduction phase, the W-phase serving as the Low-side conduction phase, and the U-phase serving as the non-energization phase.

The section 3 includes the V-phase serving as the High-side conduction phase, the U-phase serving as the Low-side conduction phase, and the W-phase serving as the non-energization phase. The section 4 includes the W-phase serving as the High-side conduction phase, the U-phase serving as the Low-side conduction phase, and the V-phase serving as the non-energization phase. The section 5 includes the W-phase serving as the High-side conduction phase, the V-phase serving as the Low-side conduction phase, and the U-phase serving as the non-energization phase.

The two-phase modulation method performed by the motor control device 1 uses three phases with two phases serving as PWM phases that are PWM-controlled, and with the remaining one phase serving as a fixed phase in which any one of the upper arm 11 and the lower arm 12 is always turned on, as described above. Examples of the two-phase modulation method that can be performed by the motor control device 1 include a two-phase modulation method of a Min-type, a two-phase modulation method of a Max type, and a two-phase modulation method of a Min-Max type.

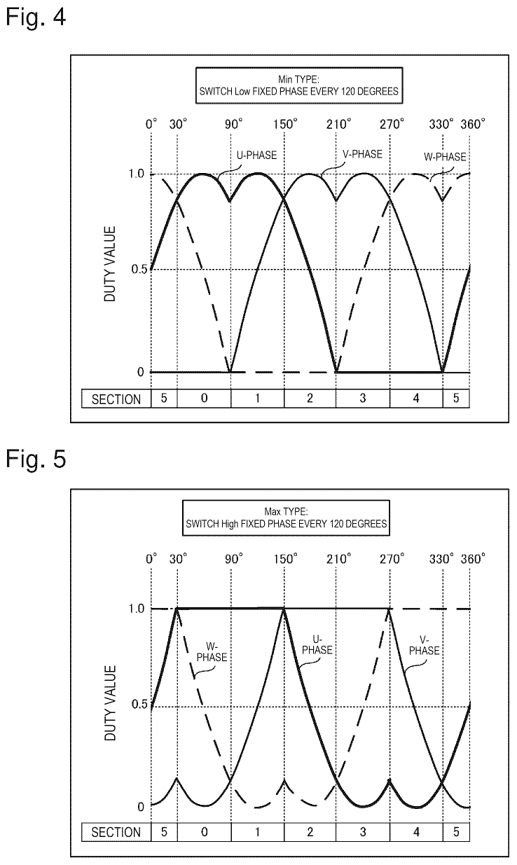

FIG. 4 is a diagram illustrating a state of each phase in each section of a Min type performed by the motor control device 1 according to the embodiment. As illustrated in FIG. 4, the two-phase modulation method of a Min type is configured to perform control of turning on and off the upper arm 11 and the lower arm 12 of the PWM phase by PWM control and fixing the lower arm 12 of the fixed phase to the ON state while switching a combination of the PWM phase and the fixed phase every 120 degrees. In the two-phase modulation method of a Min type, the fixed phase is a Low fixed phase in which the lower arm 12 is always turned on, and the U-phase and the W-phase each serve as the PWM phase, and the V-phase serve as the Low fixed phase in sections 0 and 5 that are switched every 120 degrees. In the sections 1 and 2, the U-phase and the V-phase each serve as the PWM phase, and the W-phase serves as the Low fixed phase. In the sections 3 and 4, the V-phase and the W-phase each serve as the PWM phase, and the U-phase serves as the Low fixed phase.

FIG. 5 is a diagram illustrating a state of each phase in each section of a Max type performed by the motor control device 1 according to the embodiment. As illustrated in FIG. 5, the two-phase modulation method of a Max type is configured to perform control of turning on and off the upper arm 11 and the lower arm 12 of the PWM phase by the PWM control and fixing the upper arm 11 of the fixed phase to the ON state while switching the combination of the PWM phase and the fixed phase every 120 degrees. In the two-phase modulation method of a Max type, the fixed phase is a High fixed phase in which the upper arm 11 is always turned on, and is switched every 120 degrees. In the sections 0 and 1, the V-phase and the W-phase each serve as the PWM phase, and the U-phase serves as the High fixed phase. In the sections 2 and 3, the U-phase and the W-phase each serve as the PWM phase, and the V-phase serves as the High fixed phase. In the sections 4 and 5, the U-phase and the V-phase each serve as the PWM phase, and the W-phase serves as the High fixed phase.

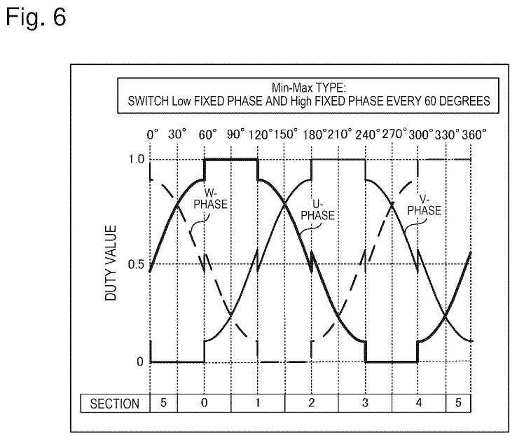

FIG. 6 is a diagram illustrating a state of each phase in each section of a Min-Max type performed by the motor control device 1 according to the embodiment. As illustrated in FIG. 6, the two-phase modulation method of a Min-Max type is configured to switch between control of the two-phase modulation method of a Min type and control of the two-phase modulation method of a Max type every 60 degrees, and alternately switch the combination of the PWM phase and the fixed phase every 60 degrees. The two-phase modulation method of a Min type and the two-phase modulation method of a Max type are switched every 60 degrees in the two-phase modulation method of a Min-Max type, so that the Low fixed phase and the High fixed phase are alternately switched every 60 degrees.

In the two-phase modulation method of a Min-Max type, the section 0 includes a range of 30° or more and less than 60° and the section 5 includes a range of 0° or more and less than 30°, the ranges including the U-phase and the W-phase each serving as the PWM phase, and the V-phase serving as the Low fixed phase. The section 0 includes a range of 60° or more and less than 90° and the section 1 includes a range of 90° or more and less than 120°, the ranges including the V-phase and the W-phase each serving as the PWM phase, and the U-phase serving as the High fixed phase. The section 1 includes a range of 120° or more and less than 150° and the section 2 includes a range of 150° or more and less than 180°, the ranges including the U-phase and the V-phase each serving as the PWM phase, and the W-phase serving as the Low fixed phase.

The section 2 includes a range of 180° or more and less than 210° and the section 3 includes a range of 210° or more and less than 240°, the ranges including the U-phase and the W-phase each serving as the PWM phase, and the V-phase serving as the High fixed phase. The section 3 includes a range of 240° or more and less than 270° and the section 4 includes a range of 270° or more and less than 300°, the ranges including the V-phase and the W-phase each serving as the PWM phase, and the U-phase serving as the Low fixed phase. The section 4 includes a range of 300° or more and less than 330° and the section 5 includes a range of 330° or more and less than 360°, the ranges including the U-phase and the V-phase each serving as the PWM phase, and the W-phase serving as the High fixed phase.

The determination unit 34 in FIG. 1 determines that the section 0 corresponds to an electrical angle of the motor 2 in a relationship of 30°≤θₑ<90°, and determines that the section 1 corresponds to an electrical angle of the motor 2 in a relationship of 90°≤θₑ<150°.

The determination unit 34 also determines that the section 2 corresponds to an electrical angle of the motor 2 in a relationship of 150°≤θₑ<210°, and determines that the section 3 corresponds to an electrical angle of the motor 2 in a relationship of 210°≤θₑ<270°. The determination unit 34 also determines that the section 4 corresponds to an electrical angle of the motor 2 in a relationship of 270°≤θₑ<330°, and determines that the section 5 corresponds to an electrical angle of the motor 2 in a relationship of 0°≤θₑ<30° or 330°≤θₑ<360°.

The determination unit 34 determines not only the sections described above, but also whether the motor 2 has an electrical angle equal to an angle at the center of each of the sections. The determination unit 34 outputs section information to the conduction controller 36, the section information including information indicating the determined angle at the center of each of the sections. The determination unit 34 may be configured to output information on the electrical angle of the motor 2 to the conduction controller 36 instead of the section information.

The determination unit 34 also determines switching between the 120-degree energization method and the two-phase modulation method based on a load condition of the motor 2, a drive condition of the motor 2, or the like. The present embodiment proposes a method for switching from the two-phase modulation method to the 120-degree energization method.

When determining the switching from the two-phase modulation method to the 120-degree energization method, the determination unit 34 outputs a method switching request to the conduction controller 36. Consequently, the conduction controller 36 switches control of the motor 2 from control of the two-phase modulation method to control of the 120-degree energization method. Alternatively, advance control may be performed in the two-phase modulation method.

As described above, the motor control device 1 is capable of switching from the two-phase modulation method to the 120-degree energization method based on the load condition of the motor 2, the drive condition of the motor 2, or the like. Consequently, the motor control device 1 enables not only high efficient driving of the motor 2 suitable for the load condition or the drive condition of the motor 2, but also stabilizing of driving of the motor 2 in a wide range of rotational speed.

As described above, the 120 degree energization information included in the setting unit 35 of FIG. 1 is information on the 120-degree energization method, and includes conduction type information and control type information. The conduction type information included in the 120-degree energization information indicates one conduction type selected from a plurality of conduction types in the 120-degree energization method. The control type information included in the 120-degree energization information indicates one control type selected from a plurality of control types in the 120-degree energization method.

The plurality of conduction types in the 120-degree energization method includes a valley ON type and a peak ON type that are different from each other in phase of a waveform of the gate signal Sp for turning on and off the upper arm 11 of the PWM phase. The gate signal Sp for turning on and off the PWM phase upper arm 11 is input to the gate driver 15 and amplified by the gate driver 15. The amplified signal is input to the upper arm 11 of the PWM phase. The gate signal Sp for turning on and off the upper arm 11 of the PWM phase has a waveform that is an example of an energization waveform for turning on and off the upper arm 11 of the PWM phase. The valley ON type and the peak ON type are different from each other in a combination of a comparison result between the carrier wave Scw and the compare value Scomp, and one arm of the upper arm 11 and the lower arm 12, the one arm being conducted. The valley ON type is an example of a first conduction type, and the peak ON type is an example of a second conduction type.

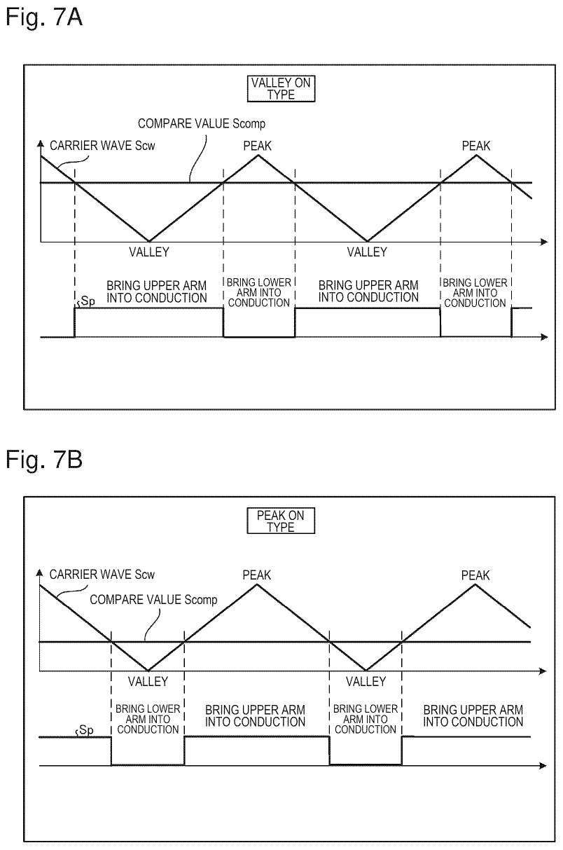

FIG. 7A is a diagram illustrating an example of control in a case where the conduction type used in the motor control device 1 according to the embodiment is the valley ON type. As illustrated in FIG. 7A, the valley ON type is configured such that the upper arm 11 is turned on and brought into conduction when the compare value Scomp is higher than the carrier wave Scw, and the lower arm 12 is turned on and brought into conduction when the compare value Scomp is lower than the carrier wave Scw.

FIG. 7B is a diagram illustrating an example of control for the conduction type used in the motor control device 1 according to the embodiment, the conduction type being the peak ON type. As illustrated in FIG. 7B, the peak ON type is configured such that the upper arm 11 is turned on and brought into conduction when the compare value Scomp is lower than the carrier wave Scw, and the lower arm 12 is turned on and brought into conduction when the compare value Scomp is higher than the carrier wave Scw.

Although the gate signal Sp of the valley ON type has a waveform in which the center of an ON period is a position in a valley as illustrated in FIG. 7A, the gate signal Sp of the peak ON type has a waveform in which a position in a valley is an OFF period as illustrated in FIG. 7A. The ON period is a period in which the upper arm 11 is turned on, and the OFF period is a period in which the upper arm 11 is turned off. Although the gate signal Sp of the peak ON type has a waveform in which the center of an ON period is a position in a peak as illustrated in FIG. 7B, the gate signal Sp of the valley ON type has a waveform in which a position in a peak is an OFF period as illustrated in FIG. 7A. As described above, the valley ON type and the peak ON type have a relationship in which the center of the ON period of an energization waveform of one conduction type is in the OFF period of an energization waveform of the other conduction type.

Next, a plurality of control types in the 120-degree energization method will be described. The plurality of control types in the 120-degree energization method includes a High-side PWM control type, a Low-side PWM control type, and a Both-side PWM control type.

The High-side PWM control type performs control in which the upper arm 11 and the lower arm 12 of the High-side conduction phase is turned on and off by the PWM control, and the lower arm 12 of the Low-side conduction phase is fixed in an ON state.

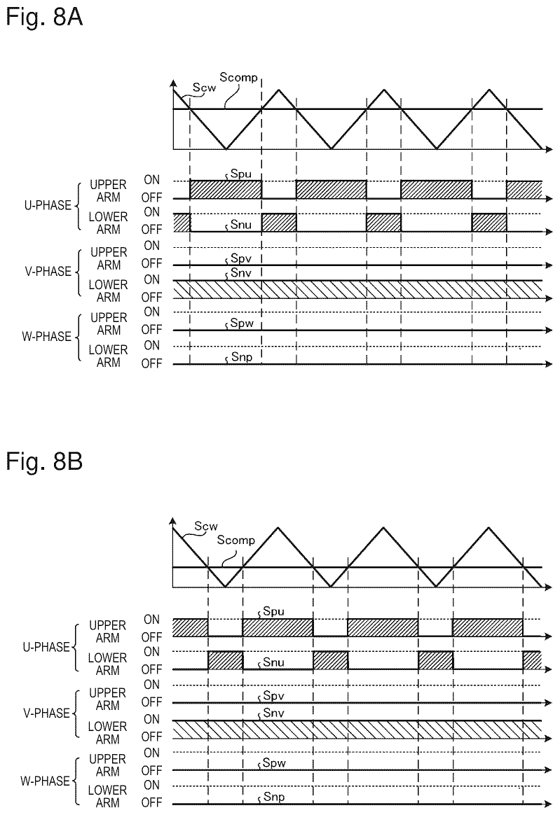

FIG. 8A is a diagram illustrating an example of control of the inverter circuit 10 by the 120-degree energization method of the High-side PWM control type and the valley ON type in the motor control device 1 according to the embodiment. FIG. 8A illustrates the example in which the conduction type is the valley ON type, and a section determined by the determination unit 34 is the section 0.

The section 0 includes the U-phase serving as the High-side conduction phase, the V-phase serving as the Low-side conduction phase, and the W-phase serving as the non-energization phase. Thus, the upper arm 11₁ and the lower arm 12₁ of the U-phase are PWM-controlled, and the lower arm 12₂ of the v-phase is fixed in the ON state as illustrated in FIG. 8A. The conduction type is the valley ON type, so that the upper arm 11₁ of the U-phase is turned on when the compare value Scomp is higher than the carrier wave Scw, and the lower arm 12₁ of the U-phase is turned on when the compare value Scomp is lower than the carrier wave Scw. In the following description, a phase in which the lower arm 12 is fixed in the ON state may be referred to as a Low fixed phase.

FIG. 8B is a diagram illustrating an example of control of the inverter circuit 10 by the 120-degree energization method of the High-side PWM control type and the peak ON type in the motor control device 1 according to the embodiment. FIG. 8B illustrates the example in which the conduction type is the peak ON type, and a section determined by the determination unit 34 is the section 0. The example illustrated FIG. 8B is different from the example illustrated FIG. 8A in that the conduction type is the peak ON type, so that the upper arm 11₁ of the U-phase is turned on when the compare value Scomp is lower than the carrier wave Scw, and the lower arm 12₁ of the U-phase is turned on when the compare value Scomp is higher than the carrier wave Scw. FIG. 8B illustrates the example in which the conduction controller 36 calculates the compare value Scomp by operation of Scomp=Pv×(1−Sduty). The duty value Sduty has a minimum value of 0 and a maximum value of 1, for example, and a period value Pv is a value at a position in a peak of the carrier wave Scw, for example. The value at the position in the peak of the carrier wave Scw is a maximum value of the carrier wave Scw. FIG. 8A illustrates the example in which the compare value Scomp is calculated by operation of Scomp=Pv×Sduty.

The Low-side PWM control type performs control in which the lower arm 12 of the High-side conduction phase is fixed in an ON state, and the upper arm 11 and the lower arm 12 of the Low-side conduction phase is turned on and off by the PWM control.

For convenience, dead time during transition of the conduction state of the upper arm and lower arm of the U-phase in FIGS. 8A and 8B is not illustrated. In practice, the dead time is provided when the upper arm and the lower arm are complementarily shifted to the ON state by the PWM control or the like. The same applies to the following drawings.

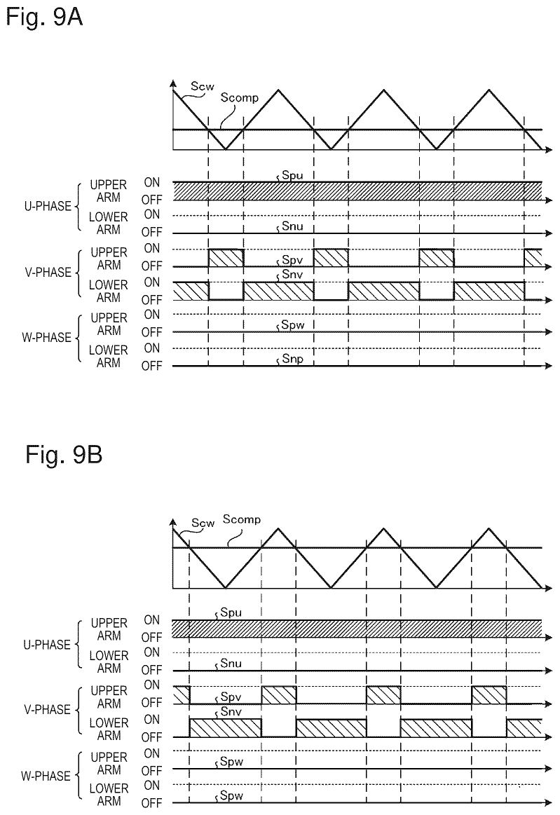

FIG. 9A is a diagram illustrating an example of control of the inverter circuit 10 by the 120-degree energization method of the Low-side PWM control type and the valley ON type in the motor control device 1 according to the embodiment. FIG. 9A illustrates the example in which the conduction type is the valley ON type, and a section determined by the determination unit 34 is the section 0 as with the example illustrated in FIG. 8A. FIG. 9A illustrates the example in which the conduction type is the valley ON type, so that the upper arm 11₂ of the V-phase is turned on when the compare value Scomp is higher than the carrier wave Scw, and the lower arm 12₂ of the V-phase is turned on when the compare value Scomp is lower than the carrier wave Scw. FIG. 9A illustrates the example in which the conduction controller 36 calculates the compare value Scomp by operation of Scomp=Pv×(1−Sduty).

FIG. 9B is a diagram illustrating an example of control of the inverter circuit 10 by the 120-degree energization method of the Low-side PWM control type and the peak ON type in the motor control device 1 according to the embodiment. FIG. 9B illustrates the example in which the conduction type is the peak ON type, and a section determined by the determination unit 34 is the section 0 as with the example illustrated in FIG. 8B.

The section 0 includes the U-phase serving as the High-side conduction phase, the V-phase serving as the Low-side conduction phase, and the W-phase serving as the non-energization phase. Thus, the upper arm 11₁ of the U-phase is fixed in the ON state, and the upper arm 11₂ and the lower arm 12₂ of the V-phase are PWM-controlled as illustrated in FIG. 9B. Then, the example is different from the example illustrated FIG. 9A in that the conduction type is the peak ON type, so that the upper arm 11₂ of the V-phase is turned on when the compare value Scomp is lower than the carrier wave Scw, and the lower arm 12₂ of the V-phase is turned on when the compare value Scomp is higher than the carrier wave Scw. FIG. 9B illustrates the example in which the compare value Scomp is calculated by operation of Scomp=Pv×Sduty.

The Both-side PWM control type performs control in which the upper arm 11 and the lower arm 12 of the High-side conduction phase are turned on and off by PWM control, and the upper arm 11 and the lower arm 12 of the Low-side conduction phase are turned on and off by the PWM control for the High-side conduction phase and complementary PWM control. In the High-side conduction phase, the upper arm 11 and the lower arm 12 are turned on and off by PWM control in which the upper arm 11 has a larger ON ratio than the lower arm 12. In the Low-side conduction phase, the upper arm 11 and the lower arm 12 are turned on and off by PWM control in which the upper arm 11 has a smaller ON ratio than the lower arm 12.

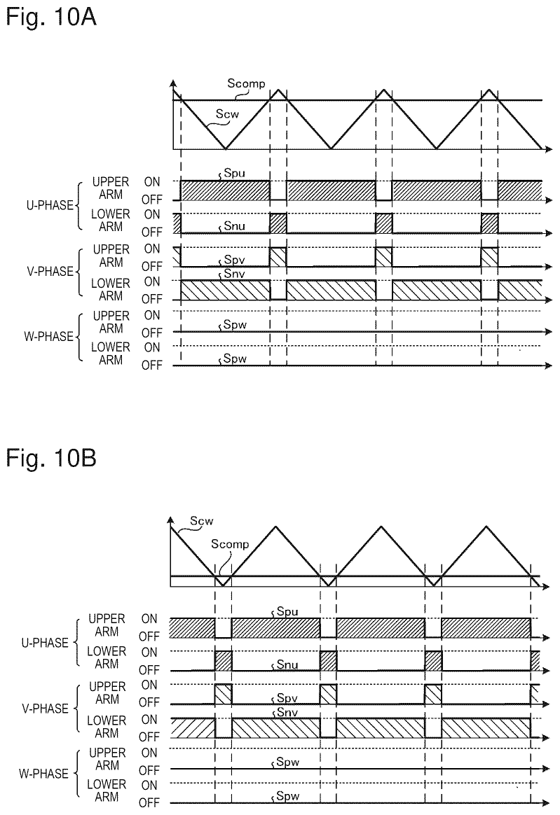

FIG. 10A is a diagram illustrating an example of control of the inverter circuit 10 by the 120-degree energization method of the Both-side PWM control type and the valley ON type in the motor control device 1 according to the embodiment. FIG. 10A illustrates the example in which the conduction type is the valley ON type, and a section determined by the determination unit 34 is the section 0 as with the example illustrated in FIG. 8A.

The section 0 includes the U-phase serving as the High-side conduction phase, the V-phase serving as the Low-side conduction phase, and the W-phase serving as the non-energization phase. Thus, the upper arm 11₁ and the lower arm 12₁ of the U-phase are turned on and off by the PWM control in which the upper arm 11₁ of the U-phase has a larger ON ratio than the lower arm 12₁ thereof, and the upper arm 11₂ and the lower arm 12₂ of the V-phase are turned on and off by the PWM control in which the upper arm 11₂ of the V-phase has a smaller ON ratio than the lower arm 12₂ thereof as illustrated in FIG. 10A. The conduction type is the valley ON type, so that the upper arm 11₁ of the U-phase and the lower arm 12₂ of the V-phase are turned on when the compare value Scomp is higher than the carrier wave Scw, and the lower arm 12₁ of the U-phase and the upper arm 11₂ of the V-phase is turned on when the compare value Scomp is lower than the carrier wave Scw. FIG. 10A illustrates the example in which the compare value Scomp is calculated by operation of Scomp=Pv×(Sduty×0.5+0.5).

FIG. 10B is a diagram illustrating an example of control of the inverter circuit 10 by the 120-degree energization method of the Both-side PWM control type and the peak ON type in the motor control device 1 according to the embodiment. FIG. 10B illustrates the example in which the conduction type is the peak ON type, and a section determined by the determination unit 34 is the section 0 as with the example illustrated in FIG. 8B. FIG. 10B illustrates the example in which the conduction type is the peak ON type, so that the upper arm 11₁ of the U-phase and the lower arm 12₂ of the V-phase are turned on when the compare value Scomp is lower than the carrier wave Scw, and the lower arm 121 of the U-phase and the upper arm 11₂ of the V-phase is turned on when the compare value Scomp is higher than the carrier wave Scw. FIG. 10B illustrates the example in which the compare value Scomp is calculated by operation of Scomp=Pv×(1−(Sduty×0.5+0.5)).

As described above, the two-phase modulation information includes the control type information. The control type information included in the two-phase modulation information indicates one control type selected from a plurality of control types in the two-phase modulation method.

The plurality of control types in the two-phase modulation method includes the Min type, Max type, and Min-Max type described above. The two-phase modulation method uses in-phase control in which the same conduction type is applied to two PWM phases and reverse-phase control in which different conduction types are applied to the two PWM phases. The in-phase control corresponds to control in which conduction of the upper arm 11 and the lower arm 12 of each of the two PWM phases is controlled by the valley ON type, for example. Then, the reverse-phase control corresponds to control in which conduction of the upper arm 11 and the lower arm 12 of one PWM phase of the two PWM phases is controlled by the valley ON type, and conduction of the upper arm 11 and the lower arm of the other PWM phase is controlled by the peak ON type.

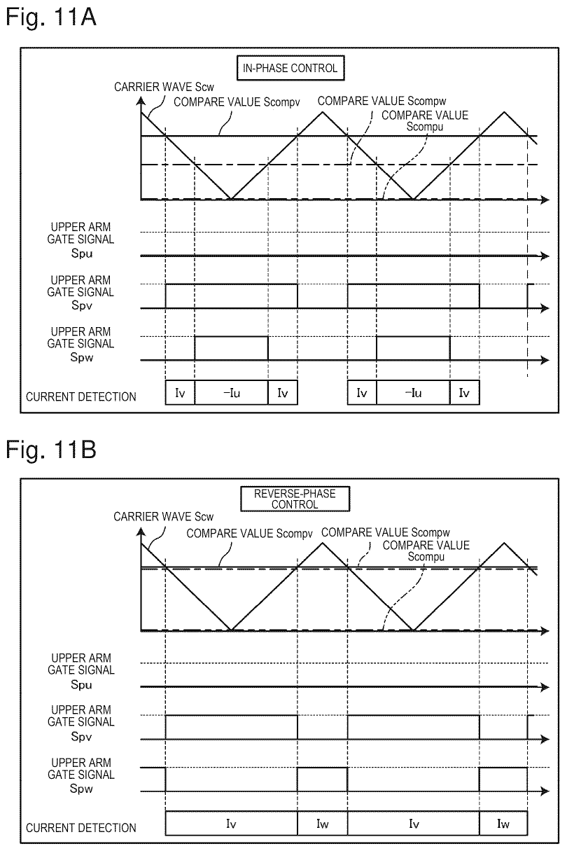

FIG. 11A is a diagram illustrating an example of control of the inverter circuit 10 by the in-phase control in the motor control device 1 according to the embodiment. FIG. 11A illustrates an example of a control signal in the two-phase modulation method of the Min type in which the V-phase and the W-phase correspond to the PWM phase and the U-phase corresponds to the Low fixed phase. FIG. 11A illustrates an upper arm gate signal Spu, an upper arm gate signal Spv, and an upper arm gate signal Spw that represent gate signals of the upper arms of the U-phase, the V-phase, and the W-phase, respectively. FIG. 11A also shows a compare value Scompu, a compare value Scompv, and a compare value Scompw that represent compare values Scomp of the U-phase, the V-phase, and the W-phase, respectively.

In FIG. 11A, the valley ON type is applied to the conduction type of the V phase and the W phase that are each the PWM phase. That is, when the compare value Scompv and the compare value Scompw are higher than the carrier wave Scw, the upper arm 11 is turned on and brought into conduction. The compare value Scompu is at the same level as a bottom of a valley of the carrier wave Scw in the U-phase of FIG. 11A, so that the upper arm is always turned off, and the lower arm is always turned on. FIG. 11A shows a period indicated by a frame including a character, “-Iu” or “Iv” represents a period in which the shunt resistor 21 of FIG. 2 can detect a U-phase current Iu and a V-phase current Iv. The in-phase control of FIG. 11A enables the shunt resistor 21 to detect currents of the U-phase and the W-phase.

FIG. 11B is a diagram illustrating an example of control of the inverter circuit 10 by reverse-phase control in the motor control device 1 according to the embodiment. In FIG. 11B, the valley ON type is applied to the conduction type of the V-phase, and the peak ON type is applied to the conduction type of the W-phase. That is, the upper arm 11 of the V-phase is turned on when the compare value Scompv is higher than the carrier wave Scw, and the upper arm 11 of the W-phase is turned on when the compare value Scompw is lower than the carrier wave Scw. FIG. 11B shows a period indicated by a frame including a character, “Iv” or “Iw” represents a period in which the shunt resistor 21 of FIG. 2 can detect a V-phase current Iv and a W-phase current Iw. The reverse-phase control of FIG. 11B enables the shunt resistor 21 to detect currents of the V-phase and the W-phase.

For example, FIG. 11A shows a gate signal of the upper arm, the gate signal having a duty ratio corresponding to the compare value Scomp. Here, the duty ratio is a ratio of a period during which the upper arm is turned on in a control period of the PWM phase. FIG. 11A shows the compare value Scompv with the highest voltage, the compare value Scompu with voltage in a lowest level, and the compare value Scompw with voltage in an intermediate level. Thus, the duty ratio is the highest in the V-phase and the lowest in the U-phase. Then, the W-phase has a duty ratio in an intermediate level. Here, phases having the maximum, intermediate, and minimum duty ratios are referred to as a maximum phase, an intermediate phase, and a minimum phase, respectively. In FIG. 11A, the V-phase, the W-phase, and the U-phase correspond to the maximum phase, the intermediate phase, and the minimum phase, respectively.

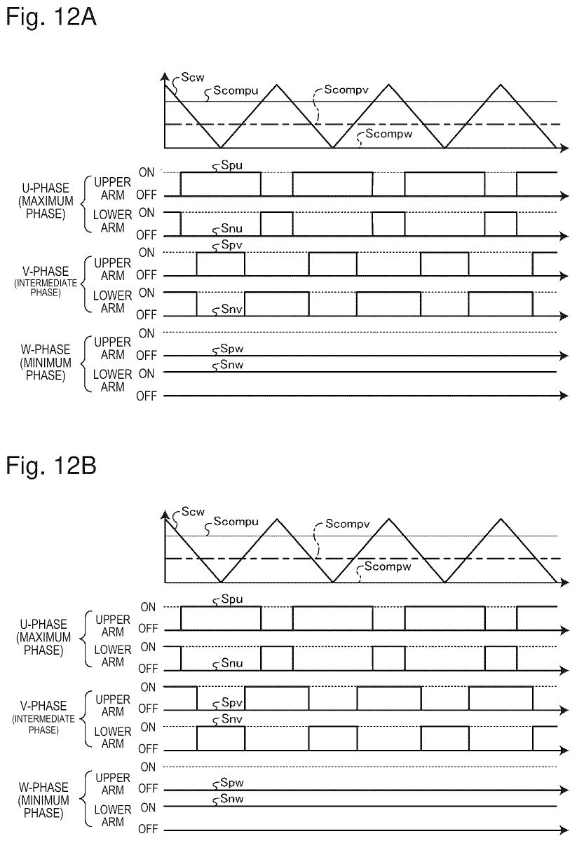

FIGS. 12A and 12B are each a diagram illustrating an example of the conduction type of the two-phase modulation method of the Min type in the motor control device 1 according to the embodiment. FIG. 12A illustrates an example of the in-phase control, and FIG. 12B illustrates an example of the reverse-phase control. FIGS. 12A and 12B each illustrates the example in which the compare value Scomp of each of the U phase, the V phase, and the W phase, the carrier wave Scw, and the gate signals Spu, Spv, and Spw are illustrated. FIGS. 12A and 12B each illustrates the example in which the U-phase and the V-phase each serve as the PWM phase, and the W-phase serves as the Low fixed phase.

The conduction type of the valley ON type is applied to the U-phase and the V-phase each serving as the PWM phase in FIG. 12A. The conduction type of each of the valley ON type and the peak ON type is applied to the U-phase and the V-phase each serving as the PWM phase in FIG. 12B.

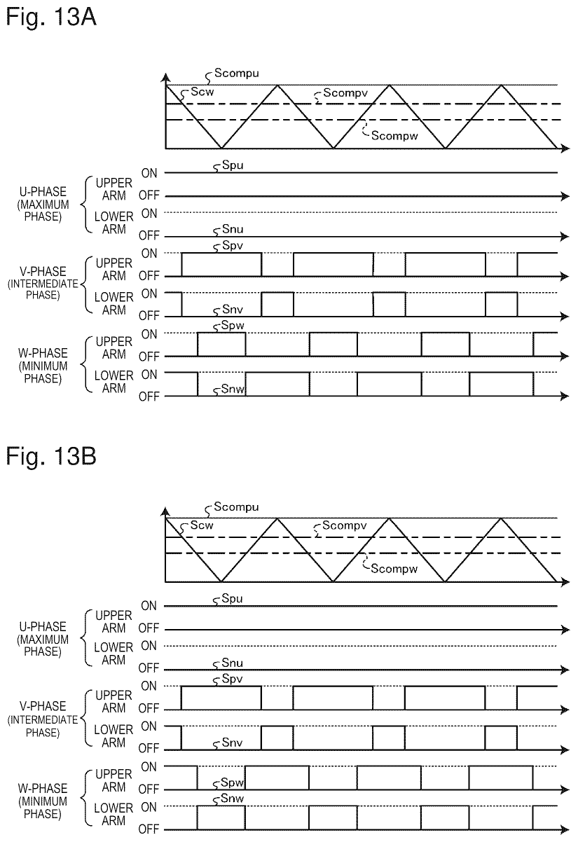

FIGS. 13A and 13B are each a diagram illustrating an example of the conduction type of the two-phase modulation method of Max type control in the motor control device 1 according to the embodiment. FIG. 13A illustrates an example of the in-phase control, and FIG. 13B illustrates an example of the reverse-phase control. FIGS. 13A and 13B each illustrates the example in which the compare value Scomp of each of the U phase, the V phase, and the W phase, the carrier wave Scw, and the gate signals Spu, Spv, and Spw are illustrated as with FIGS. 12A and 12B. FIGS. 13A and 13B each illustrates the example in which the V-phase and the W-phase each serve as the PWM phase, and the U-phase serves as the High fixed phase.

The conduction type of the valley ON type is applied to the V-phase and the W-phase each serving as the PWM phase in FIG. 13A. The conduction type of each of the valley ON type and the peak ON type is applied to the V-phase and the W-phase each serving as the PWM phase in FIG. 13B.

Until a system switching request is output from the determination unit 34, the conduction switching unit 40 controls the inverter circuit 10 by the two-phase modulation method of the control type indicated by two-phase energization information included in the setting information output from the setting unit 35.

For example, when the control type indicated by the two-phase energization information included in the setting information is the Min type, the conduction switching unit 40 drives the inverter circuit 10 by the two-phase modulation method of the Min type as illustrated in FIG. 4. When the control type indicated by the two-phase energization information included in the setting information is the Max type, the conduction switching unit 40 drives the inverter circuit 10 by the two-phase modulation method of the Max type as illustrated in FIG. 5. Then, when the control type indicated by the two-phase energization information included in the setting information is the Min-Max type, the conduction switching unit 40 drives the inverter circuit 10 by the two-phase modulation method of the Min-Max type as illustrated in FIG. 6.

For example, when the control type and the conduction type indicated by the setting information are the High-side PWM control type and the valley ON type, the conduction switching unit 40 drives the inverter circuit 10 by the 120-degree energization method of the High-side PWM control type and the valley ON type as illustrated in FIG. 8A. When the control type and the conduction type indicated by the setting information are the High-side PWM control type and the peak ON type, the conduction switching unit 40 drives the inverter circuit 10 by the 120-degree energization method of the High-side PWM control type and the peak ON type as illustrated in FIG. 8B.

Then, when the control type and the conduction type indicated by the setting information are the Low-side PWM control type and the valley ON type, the conduction switching unit 40 drives the inverter circuit 10 by the 120-degree energization method of the Low-side PWM control type and the valley ON type as illustrated in FIG. 9A. When the control type and the conduction type indicated by the setting information are the Low-side PWM control type and the peak ON type, the conduction switching unit 40 drives the inverter circuit 10 by the 120-degree energization method of the Low-side PWM control type and the peak ON type as illustrated in FIG. 9B.

Then, when the control type and the conduction type indicated by the setting information are the Both-side PWM control type and the valley ON type, the conduction switching unit 40 drives the inverter circuit 10 by the 120-degree energization method of the Both-side PWM control type and the valley ON type as illustrated in FIG. 10A. When the control type and the conduction type indicated by the setting information are the Both-side PWM control type and the peak ON type, the conduction switching unit 40 drives the inverter circuit 10 by the 120-degree energization method of the Both-side PWM control type and the peak ON type as illustrated in FIG. 10B.

When a method switching request is output from the determination unit 34, the conduction switching unit 40 controls the inverter circuit 10 by the 120-degree energization method of a control type and a conduction type indicated by 120-degree energization method information included in the setting information output from the setting unit 35.

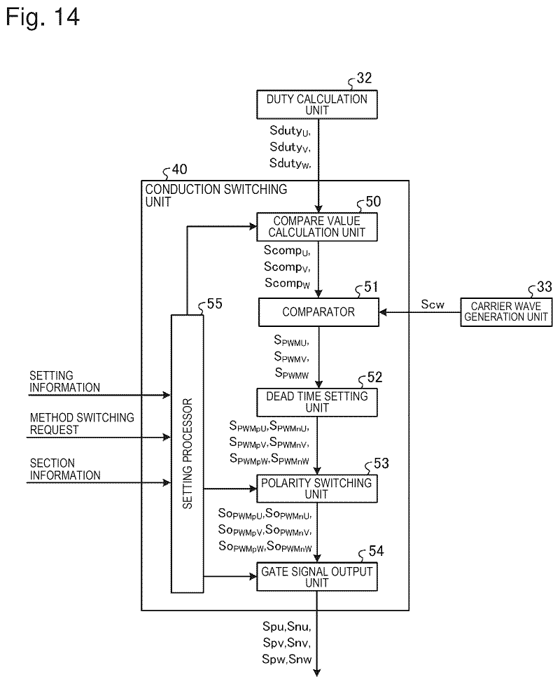

FIG. 14 is a diagram illustrating an example of a configuration of the conduction switching unit 40 in the motor control device 1 according to the embodiment. As illustrated in FIG. 14, the conduction switching unit 40 includes a compare value calculation unit 50, a comparator 51, a dead time setting unit 52, a polarity switching unit 53, a gate signal output unit 54, and a setting processor 55.

When a conduction method notified from the setting processor 55 is the 120-degree energization method, the compare value calculation unit 50 calculates compare values Scompu, Scompv, and Scompw of the U-phase, the V-phase, and the W-phase based on a conduction type and a control type notified from the setting processor 55 and the duty values Sduty_{U}, Sduty_{V}, and Sduty_{W} of the U-phase, the V-phase, and the W-phase output from the duty calculation unit 32, and outputs the compare values. When each of the compare values Scomp_{U}, Scomp_{V}, and Scomp_{W} is indicated without being individually distinguished, it may be referred to as a compare value Scomp.

For example, when the conduction method, the control type, and the conduction type notified from the setting processor 55 are the 120-degree energization method, the High-side PWM control type, and the valley ON type, the compare value calculation unit 50 outputs a value obtained by multiplying the duty value Sduty output from the duty calculation unit 32 by the period value Pv to the comparator 51 as the compare value Scomp. For this output, the compare value Scomp is expressed as Scomp 32 Pv×Sduty.

The conduction method, the control type, and the conduction type notified from the setting processor 55 are assumed to be the 120-degree energization method, the High-side PWM control type, and the peak ON type, respectively. For this assumption, the compare value calculation unit 50 outputs a value obtained by multiplying a period value Pv by a value obtained by inverting the duty value Sduty output from the duty calculation unit 32 with reference to a median value of the carrier wave Scw to the comparator 51 as the compare value Scomp. For this output, the compare value Scomp is expressed as Scomp=Pv×(1−Sduty).

Alternatively, the conduction method, the control type, and the conduction type notified from the setting processor 55 are assumed to be the 120-degree energization method, the Low-side PWM control type, and the valley ON type, respectively. For this assumption, the compare value calculation unit 50 outputs a value obtained by multiplying a period value Pv by a value obtained by inverting the duty value Sduty output from the duty calculation unit 32 with reference to a median value of the carrier wave Scw to the comparator 51 as the compare value Scomp. For this output, the compare value Scomp is expressed as Scomp=Pv×(1−Sduty).

When the conduction method, the control type, and the conduction type notified from the setting processor 55 are the 120-degree energization method, the Low-side PWM control type, and the peak ON type, respectively, the compare value calculation unit 50 outputs a value to the comparator 51 as the compare value Scomp, the value being obtained by multiplying the duty value Sduty output from the duty calculation unit 32 by the period value Pv. For this output, the compare value Scomp is expressed as Scomp=Pv×Sduty.

When the conduction method, the control type, and the conduction type notified from the setting processor 55 are the 120-degree energization method, the Both-side PWM control type, and the valley ON type, respectively, the compare value calculation unit 50 calculates a value as the compare value Scomp, the value being obtained by further multiplying the period value Pv by a value obtained by adding 0.5 to a value obtained by multiplying 0.5 to the duty value Sduty output from the duty calculation unit 32. For this calculation, the compare value Scomp is expressed as Scomp=Pv×(Sduty×0.5+0.5).

When the conduction method, the control type, and the conduction type notified from the setting processor 55 are the 120-degree energization method, the Both-side PWM control type, and the peak ON type, respectively, the compare value calculation unit 50 outputs a value to the comparator 51 as the compare value Scomp, the value being obtained by dividing a value by 1, the value being obtained by further multiplying the period value Pv by a value obtained by adding 0.5 to a value obtained by multiplying the duty value Sduty output from the duty calculation unit 32 by 0.5. For this output, the compare value Scomp is expressed as Scomp=Pv×(1−(Sduty×0.5+0.5)).

When the conduction method, the control type, and the conduction type notified from the setting processor 55 are the two-phase modulation method, the PWM control type, and the valley ON type, respectively, the compare value calculation unit 50 outputs a value to the comparator 51 as the compare value Scomp, the value being obtained by multiplying the duty value Sduty output from the duty calculation unit 32 by the period value Pv. For this output, the compare value Scomp is expressed as Scomp=Pv×Sduty.

When the conduction method, the control type, and the conduction type notified from the setting processor 55 are the two-phase modulation method, the PWM control type, and the peak ON type, respectively, the compare value calculation unit 50 outputs a value to the comparator 51 as the compare value Scomp, the value being obtained by multiplying a value inverted with respect to a median value of the carrier wave Scw, the median value being the duty value Sduty output from the duty calculation unit 32, by the period value Pv. For this output, the compare value Scomp is expressed as Scomp=Pv×(1−Sduty).

The comparator 51 compares each of the compare values Scomp_{U}, Scomp_{V}, and Scomp_{W} of the U-phase, the V-phase, and the W-phase output from the compare value calculation unit 50 with the carrier wave Scw output from the carrier wave generation unit 33, and generates PWM signals S_{PWMU}, S_{PWMV}, and S_{PWMW} of the U-phase, the V-phase, and the W-phase based on a result of the comparison.

For example, the comparator 51 generates the PWM signal S_{PWMU} based on a result of the comparison between the compare value Scomp_{U} and the carrier wave Scw. The comparator 51 generates the PWM signal S_{PWMV} based on a result of the comparison between the compare value Scomp_{V} and the carrier wave Scw. The comparator 51 also generates the PWM signal S_{PWMW} based on a result of the comparison between the compare value Scomp_{W} and the carrier wave Scw. When the PWM signals S_{PWMU}, S_{PWMV}, and S_{PWMW} of the U-phase, the V-phase, and the W-phase are each described below without being individually distinguished, they may be referred to as PWM signals S_{PWM}. As described above, the PWM signal S_{PWM} is generated based on the carrier wave Scw and the compare value Scomp, and is used in the conduction switching unit 40 to generate the gate signals Sp and Sn of the PWM phase.

The dead time setting unit 52 generates a first PWM signal S_{PWMpU} and a second PWM signal S_{PWMnU} with dead time in which the PWM signal S_{PWMU} output from the comparator 51 and a complementary signal thereof are provided with the dead time, and outputs the generated first PWM signal S_{PWMpU} and second PWM signal S_{PWMnU}.

Then, the dead time setting unit 52 generates a first PWM signal S_{PWMpV} and a second PWM signal S_{PWMnV} with dead time in which the PWM signal S_{PWMV} output from the comparator 51 and a complementary signal thereof are provided with the dead time, and outputs the generated first PWM signal S_{PWMpV} and second PWM signal S_{PWMnV}.

The dead time setting unit 52 also generates a first PWM signal S_{PWMpW} and a second PWM signal S_{PWMnW} with dead time in which the PWM signal S_{PWMW} output from the comparator 51 and a complementary signal thereof are provided with the dead time, and outputs the generated first PWM signal S_{PWMpW} and second PWM signal S_{PWMnw}. When the first PWM signals S_{PWMpU}, S_{PWMpV}, and S_{PWMpW} are each described below without being individually distinguished, they may be referred to as a first PWM signal S_{PWMp}. When the second PWM signals S_{PWMnU}, S_{PWMnV}, and S_{PWMnW} are each described below without being individually distinguished, they may be referred to as a second PWM signal S_{PWMn}.

The polarity switching unit 53 sets a conduction type in the PWM phase based on information notified from the setting processor 55. For example, the polarity switching unit 53 outputs one of the first PWM signal S_{PWMpU} and the second PWM signal S_{PWMnU} as a third PWM signal So_{PWMpU} and outputs the other as a fourth PWM signal So_{PWMnU} based on the information notified from the setting processor 55. Then, the polarity switching unit 53 outputs one of the first PWM signal S_{PWMpV} and the second PWM signal S_{PWMnV} as a third PWM signal So_{PWMpV} and outputs the other as a fourth PWM signal So_{PWMnV} based on the information notified from the setting processor 55.

The polarity switching unit 53 also outputs one of the first PWM signal S_{PWMpW} and the second PWM signal S_{PWMnW} as a third PWM signal So_{PWMpW} and outputs the other as a fourth PWM signal So_{PWMnW} based on the information notified from the setting processor 55. When the third PWM signals So_{PWMpU}, So_{PWMpV}, and So_{PWMpW} are each described below without being individually distinguished, they may be referred to as a third PWM signal So_{PWMp}. When the fourth PWM signals So_{PWMnU}, So_{PWMnV}, and So_{PWMnW} are each described below without being individually distinguished, they may be referred to as a fourth PWM signal So_{PWMn}.

The gate signal output unit 54 outputs the gate signals Spu, Snu, Spv, Snv, Spw, and Snw based on the information notified from the setting processor 55 and the third PWM signals So_{PWMpU}, So_{PWMpV}, and So_{PWMpW}, and the fourth PWM signals So_{PWMnU}, So_{PWMnV}, and So_{PWMnW}, output from the polarity switching unit 53.

The information notified from the setting processor 55 includes information indicating whether each of the U phase, the V phase, and the W phase is a PWM phase, a Low fixed phase, a High fixed phase, or a non-energization phase. The gate signal output unit 54 outputs the third PWM signal So_{PWMp} and the fourth PWM signal So_{PWMn} as gate signals Sp and Sn in the PWM phase, respectively.

Then, the gate signal output unit 54 outputs the gate signals Sp and Sn as gate signals of the Low fixed phase, the gate signals being for turning off the upper arm 11 of the Low fixed phase and turning on the lower arm 12 of the Low fixed phase. The gate signal output unit 54 also outputs the gate signals Sp and Sn as gate signals of the High fixed phase, the gate signals being for turning on the upper arm 11 of the High fixed phase and turning off the lower arm 12 of the High fixed phase.

The gate signal output unit 54 also outputs a gate signal as a gate signal of the non-energization phase, the gate signal being for turning off the upper arm 11 of the High fixed phase and turning off the lower arm 12 of the High fixed phase.

Gate signals of the U-phase, the V-phase, and the W-phase output from the gate signal output unit 54 are input to the gate driver 15, and amplified by the gate driver 15. The amplified gate signals are input to the upper arm 11 and the lower arm 12 of each of the V-phase and the W-phase. As described above, the gate signal of the PWM phase is generated based on the PWM signal S_{PWM}, and the gate signal of the non-energization phase is for turning off the upper arm 11 and the lower arm 12 of the non-energization phase. Then, the gate signal of the Low fixed phase is for turning off the upper arm 11 of the Low fixed phase and turning on the lower arm 12 of the Low fixed phase, and the gate signals Sp and Sn of the High fixed phase are for turning on the upper arm 11 of the High fixed phase and turning off the lower arm 12 of the High fixed phase.

The setting processor 55 controls the compare value calculation unit 50, the polarity switching unit 53, and the gate signal output unit 54 based on the setting information output from the setting unit 35, and the section information and the method switching request output from the determination unit 34.

At startup, the setting processor 55 notifies the compare value calculation unit 50, the polarity switching unit 53, and the gate signal output unit 54 of information corresponding to the 120-degree energization information included in the setting information output from the setting unit 35.

As described above, the switching compensation unit 41 performs switching compensation when a method switching request is output from the determination unit 34. This switching compensation can be performed by performing switching at timing when ON-OFF states of the upper arm 11 and the lower arm 12 of each of the U phase, the V phase, and the W phase do not change, or at timing of switching to the non-energization phase in each of the U phase, the V phase, and the W phase.

Specifically, the switching compensation unit 41 performs switching compensation for causing an upper arm and a lower arm in each of two energization phases of the 120-degree energization method to be identical in an ON-OFF state before and after switching. For example, the switching compensation unit 41 sets a conduction type of a PWM phase of the two energization phases to the conduction type of the corresponding PWM phase of the two-phase modulation method before and after the switching. The switching compensation unit 41 can also perform compensation by performing control of setting switching timing to a period in which an upper arm and a lower arm of the intermediate phase are respectively turned off and turned on when switching from the two-phase modulation method of the Min type. Alternatively, the switching compensation unit 41 can also perform compensation by performing control of setting switching in a period in which the upper arm and the lower arm of the intermediate phase are respectively in the ON state and the OFF state when switching from the two-phase modulation method of the Max type.

This configuration prevents the upper arm 11 and the lower arm 12 from being turned on and off at the time of switching from the two-phase modulation method to the 120-degree energization method. Thus, the motor control device 1 enables suppressing a short circuit of the upper arm 11 and the lower arm 12 of the same phase in the inverter circuit 10 in a state without dead time.

The switching compensation unit 41 can cause the upper arm 11 and the lower arm 12 in each of the two energization phases to be identical in an ON-OFF state before and after switching from the two-phase modulation method to the 120-degree energization method by controlling the polarity switching unit 53 of the conduction switching unit 40. A configuration of the conduction switching unit 40 is not limited to the example described above, and may be any configuration as long as the upper arm 11 and the lower arm 12 in each of the two energization phases can be identical in an ON-OFF state by the switching compensation unit 41 before and after the switching from the two-phase modulation method to the 120-degree energization method.

Here, switching between sections when switching compensation by the switching compensation unit 41 is not performed in the conduction controller 36 will be described.

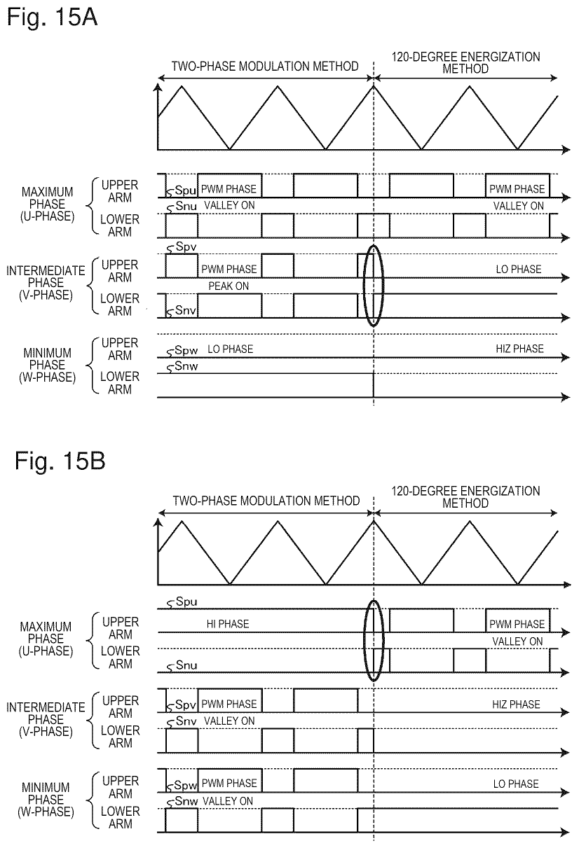

FIGS. 15A and 15B are each a diagram illustrating an example of switching from the two-phase modulation method to the 120-degree energization method when switching compensation is not performed in the motor control device 1 according to the embodiment. FIGS. 15A and 15B show “LO phase”, “HI phase”, and “HIZ phase” that represent the Low fixed phase, the High fixed phase, and the non-energization phase, respectively. The expression, “PWM phase”, is also used in the 120-degree energization method. In FIGS. 15A and 15B, the U-phase, the V-phase, and the W-phase are the maximum phase, the intermediate phase, and the minimum phase, respectively.

FIG. 15A illustrates an example in which the U-phase, the V-phase, and the W-phase transition from the PWM phase (valley ON type), the PWM phase (peak ON type), and the Low fixed phase in the two-phase modulation method to the PWM phase (valley ON type), the Low fixed phase, and the non-energization phase in the 120-degree energization method, respectively. In the intermediate phase (V-phase), the upper arm transitions from an ON state to an OFF state, and the lower arm transitions from an OFF state to an ON state (a part surrounded by an ellipse). At this time, the ON states of the upper and lower arms may overlap with each other.

FIG. 15B illustrates an example in which the U-phase, the V-phase, and the W-phase transition from the High fixed phase, the PWM phase (valley ON type), and the PWM phase (valley ON type) in the two-phase modulation method to the PWM phase (valley ON type), the non-energization phase, and the Low fixed phase in the 120-degree energization method, respectively. In the maximum phase (U-phase), the upper arm transitions from an ON state to an OFF state, and the lower arm transitions from an OFF state to an ON state. As with FIG. 15A, the ON states of the upper and lower arms may overlap with each other.

As described above, when the method switching request is output from the determination unit 34, the switching compensation unit 41 performs switching compensation for causing the upper arm 11 and the lower arm 12 of the same phase to be identical in an ON-OFF state before and after switching from the 120-degree energization method to the two-phase modulation method.

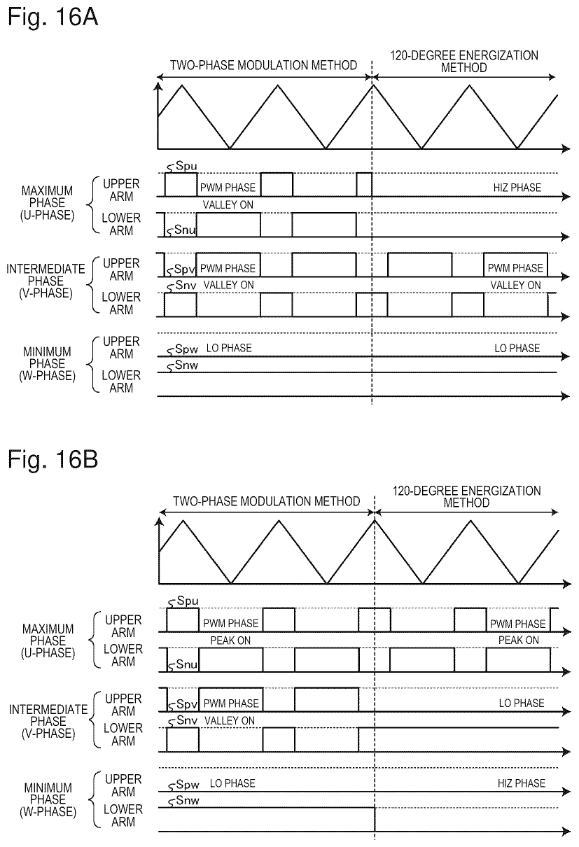

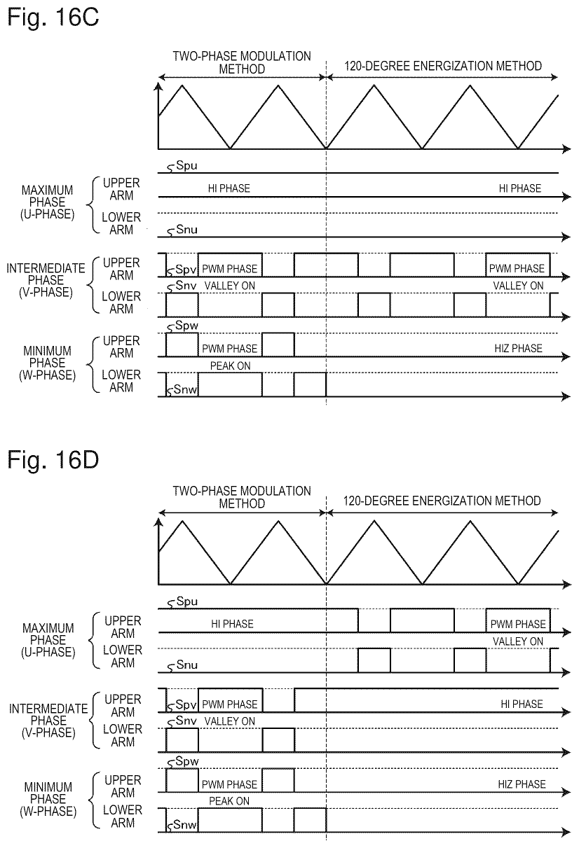

FIGS. 16A to 16D are each a diagram illustrating an example of switching from the two-phase modulation method to the 120-degree energization method when switching compensation is performed in the motor control device 1 according to the embodiment.

FIG. 16A illustrates an example in which the U-phase, the V-phase, and the W-phase transition from the PWM phase (peak ON type), the PWM phase (valley ON type), and the Low fixed phase in the two-phase modulation method (Min type) to the non-energization phase, the PWM phase (valley ON type), and the Low fixed phase in the 120-degree energization method, respectively. In the PWM phase (V-phase) of the 120-degree energization method, the conduction type (valley ON type) is maintained.

FIG. 16B illustrates an example in which the U-phase, the V-phase, and the W-phase transition from the PWM phase (peak ON type), the PWM phase (valley ON type), and the Low fixed phase in the two-phase modulation method (Min type) to the PWM phase (peak ON type), the Low fixed phase, and the non-energization phase in the 120-degree energization method, respectively. The intermediate phase (V-phase) is switched when the upper arm and the lower arm are turned off and turned on, respectively.

FIG. 16C illustrates an example in which the U-phase, the V-phase, and the W-phase transition from the High fixed phase, the PWM phase (valley ON type), and the PWM phase (peak ON type) in the two-phase modulation method (Max type) to the High fixed phase, the PWM phase (valley ON type), and the non-energization phase in the 120-degree energization method, respectively. The intermediate phase (V-phase) is switched when the upper arm and the lower arm are in the ON state and the OFF state, respectively.

FIG. 16D illustrates an example in which the U-phase, the V-phase, and the W-phase transition from the High fixed phase, the PWM phase (valley ON type), and the PWM phase (peak ON type) in the two-phase modulation method (Max type) to the PWM phase (valley ON type), the High fixed phase, and the non-energization phase in the 120-degree energization method, respectively. The intermediate phase (V-phase) is switched when the upper arm and the lower arm are in the ON state and the OFF state, respectively.

Consequently, when the switching compensation unit 41 performs switching compensation, the upper and lower arms can be prevented from being simultaneously turned on.

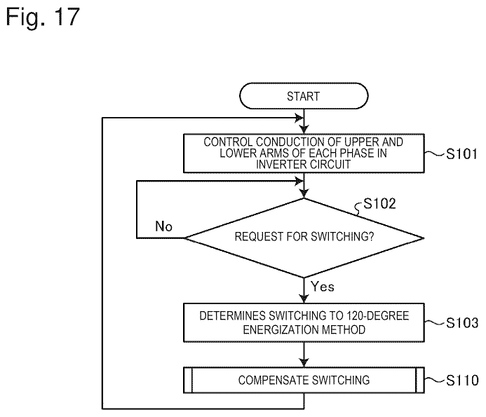

FIG. 17 is a diagram illustrating an example of motor control processing according to the embodiment. FIG. 17 is a flowchart illustrating a procedure of processing in the conduction controller 36 and the determination unit 34. First, the conduction controller 36 controls conduction of the upper arm 11 and the lower arm 12 of each phase in the inverter circuit 10 (step S101). Next, when a request for switching to the 120-degree energization method is issued (Yes in step S102), the determination unit 34 determines switching to the 120-degree energization method (step S103). Next, the switching compensation unit 41 performs switching compensation processing (step S110). Then, the processing proceeds to step S101. Steps S101 and S103 correspond to a conduction control procedure and a determination procedure, respectively. Step S110 corresponds to a switching compensation procedure. Steps S101 and S103 correspond to a conduction control step and a determination step, respectively. Then, step SS110 corresponds to a switching compensation step.

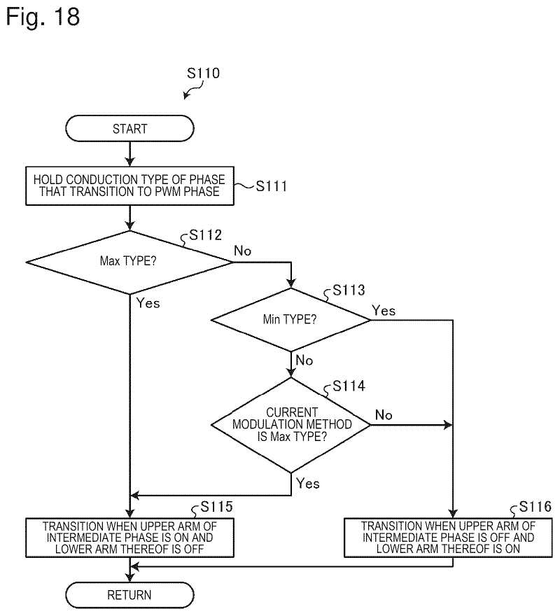

FIG. 18 is a diagram illustrating an example of switching compensation processing according to the embodiment.

FIG. 18 is a flowchart illustrating a procedure of processing in the switching compensation unit 41. FIG. 18 illustrates processing of the switching compensation (step S110) in FIG. 17. First, the switching compensation unit 41 holds a conduction type of a phase that transitions to the PWM phase of the 120-degree energization method (step S111). Next, the switching compensation unit 41 determines whether the two-phase modulation method is the Max type (step S112). As a result, when the method is the Max type (Yes in step S112), the switching compensation unit 41 proceeds to the processing of step S115.

In contrast, when the method is not the Max type (No in step S112), the switching compensation unit 41 determines whether the two-phase modulation method is the Min type (step S113). As a result, when the method is the Min type (Yes in step S113), the switching compensation unit 41 proceeds to the processing of step S116. In contrast, when the method is not the Min type (No in step S113), the switching compensation unit 41 determines that the method is the Min-Max type. The switching compensation unit 41 determines whether the current modulation method is the Max type (step S114). As a result, when the method is the Max type (Yes in step S114), the switching compensation unit 41 proceeds to the processing of step S115. In contrast, when the current modulation method is not the Max type (No in step S114), the switching compensation unit 41 proceeds to the processing of step S116.

In step S115, the switching compensation unit 41 causes transition to the 120-degree energization method when the upper arm 11 of the intermediate phase is turned on and the lower arm 12 thereof is turned off, and returns to the original processing. In step S116, the switching compensation unit 41 causes transition to the 120-degree energization method when the upper arm 11 of the intermediate phase is turned off and the lower arm 12 thereof is turned on, and returns to the original processing. The conduction type held in step S111 is applied to the conduction type of the PWM phase in the 120-degree energization method.

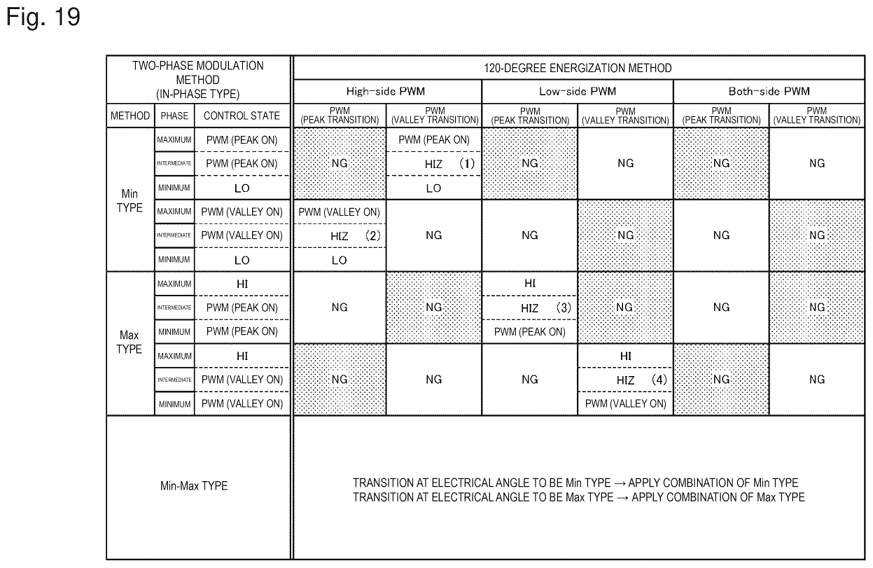

FIG. 19 is a diagram illustrating an example of a combination in which a short circuit does not occur in upper and lower arms during transition under in-phase control of the two-phase modulation method. FIG. 19 illustrates an example of the combination of phase states compensated by the switching compensation unit 41 before and after switching. FIG. 19 illustrates two-phase modulation methods of the Min type, the Max type, and the Min-Max type of the in-phase control. Each of the Min type and the Max type is described with the peak ON type and the valley ON type. The 120-degree energization method is separately described for the High-side PWM, the Low-side PWM, and the Both-side PWM, under peak transition and valley transition. Here, the peak transition is for switching performed at a position near a peak of a carrier wave. Then, the valley transition is for switching performed at a position near a valley of the carrier wave.

The position near the peak is in a range in which ON-OFF states of the upper arm 11 and the lower arm 12 of the PWM phase are not switched with respect to ON-OFF states of the upper arm 11 and the lower arm 12 of the PWM phase at the position of the peak. The range in which ON and OFF states of the upper arm 11 and the lower arm 12 of the PWM phase are not switched can also be said to be a range in which a magnitude relationship between the carrier wave Scw and the compare value Scomp of the PWM phase does not change with respect to a magnitude relationship between the carrier wave Scw and the compare value Scomp of the PWM phase at the position of the peak. Similarly, the position near the valley is in a range in which ON-OFF states of the upper arm 11 and the lower arm 12 of the PWM phase are not switched with respect to ON-OFF states of the upper arm 11 and the lower arm 12 of the PWM phase at the position of the valley.

As illustrated in FIG. 19, when the PWM phase is the peak ON type in the two-phase modulation method (in-phase) of the Min type, switching to the High-side PWM (peak transition) can be performed (1). At this time, the maximum phase (PWM phase), the intermediate phase (PWM phase), and the minimum phase (Low fixed phase) of the two-phase modulation method are caused to transition to the PWM phase, the non-energization phase, and the Low fixed phase of the 120-degree energization method, respectively. The switching is performed near the bottom of the valley of the carrier wave.

When the PWM phase is the valley ON type in the two-phase modulation method (in-phase) of the Min type, switching to the High-side PWM (valley transition) can be performed (2). At this time, the maximum phase (PWM phase), the intermediate phase (PWM phase), and the minimum phase (Low fixed phase) of the two-phase modulation method are caused to transition to the PWM phase, the non-energization phase, and the Low fixed phase of the 120-degree energization method, respectively. The switching is performed near the apex of the peak of the carrier wave.

When the PWM phase is the peak ON type in the two-phase modulation method (in-phase) of the Max type, switching to the Low-side PWM (peak transition) can be performed (3). At this time, the maximum phase (PWM phase), the intermediate phase (PWM phase), and the minimum phase (Low fixed phase) of the two-phase modulation method are caused to transition to the High fixed phase, the non-energization phase, and the PWM phase of the 120-degree energization method, respectively. The switching is performed near the apex of the peak of the carrier wave.

When the PWM phase is the valley ON type in the two-phase modulation method (in-phase) of the Max type, switching to the Low-side PWM (valley transition) can be performed (4). At this time, the maximum phase (PWM phase), the intermediate phase (PWM phase), and the minimum phase (Low fixed phase) of the two-phase modulation method are caused to transition to the High fixed phase, the non-energization phase, and the PWM phase of the 120-degree energization method, respectively. The switching is performed near the bottom of the valley of the carrier wave.

In the two-phase modulation method (in-phase) of the Min-Max type, a combination of the Min type is applied when switching is performed at an electrical angle to be the Min type. When switching is performed at an electrical angle to be a Max type, a combination of the Min type is applied.

These items (1) to (4) each represent a switchable combination that does not cause a short circuit between the upper and lower arms even when advance control is applied. When this advance control is applied, change from the PWM phase to the non-energization phase and change from the non-energization phase to the Low fixed phase at the time of switching, and reverse change thereof are assumed.

FIG. 19 shows parts each with “NG” representing a combination that causes a short circuit between the upper and lower arms at the time of switching. The parts include a part with dot hatching, the part representing a combination that may cause a short circuit between the upper and lower arms in consideration of the advance control.

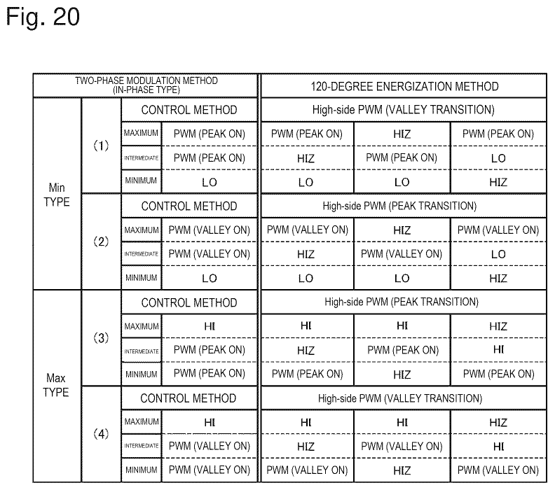

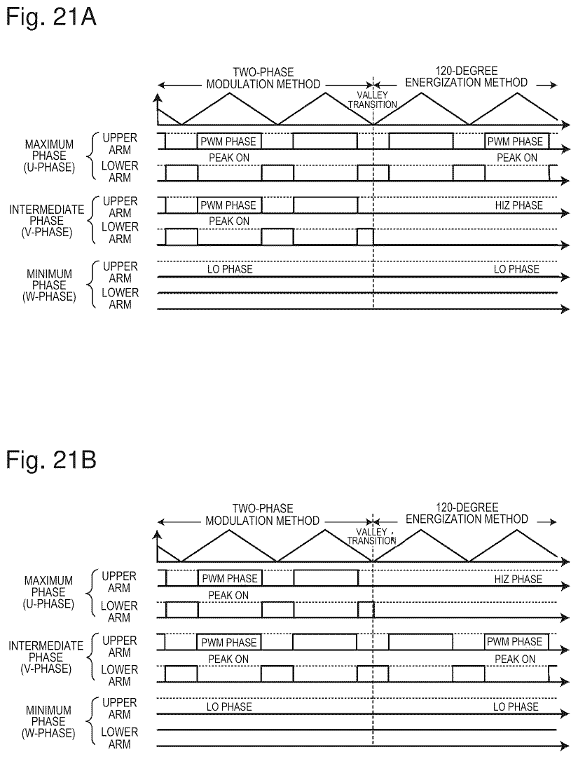

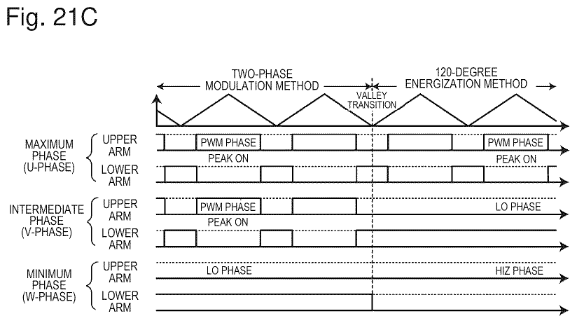

FIG. 20 is a diagram illustrating an example of the combination in which a short circuit does not occur in the upper and lower arms during the transition under the in-phase control of the two-phase modulation method. FIG. 20 is a diagram in which a combination considering the advance control is added to the combination of each of the items (1) to (4) in FIG. 19. FIG. 20 shows the 120-degree energization method with combinations including a combination at the left end in which the combination (1) and the like in FIG. 19 are described. FIG. 20 shows the 120-degree energization method with two combinations on the right side in which a phase control method is assumed to be changed by the advance control performed in the combination (1) and the like in FIG. 19. The three combinations in each of the items (1) to (4) in the drawing are verified using FIGS. 21 to 24.

FIGS. 21A to 21C are each a diagram illustrating an example of switching in the two-phase modulation method (Min type, PWM phase peak ON type of in-phase control). FIGS. 21A to 21C illustrate examples in which the three respective combinations in the item (1) of FIG. 20 are applied.

FIG. 21A illustrates a case where the U-phase, the V-phase, and the W-phase transition from the PWM phase (peak ON type), the PWM phase (peak ON type), and the Low fixed phase in the two-phase modulation method to the PWM phase (peak ON type), the non-energization phase, and the Low fixed phase in the 120-degree energization method, respectively. In the PWM phase (U-phase) of the 120-degree energization method, the conduction type (peak ON type) is maintained. The intermediate phase (V-phase) is switched when the upper arm and the lower arm are turned off and turned on, respectively.

FIG. 21B illustrates a case where the U-phase, the V-phase, and the W-phase transition from the PWM phase (peak ON type), the PWM phase (peak ON type), and the Low fixed phase in the two-phase modulation method to the non-energization phase, the PWM phase (peak ON type), and the Low fixed phase in the 120-degree energization method, respectively. In the PWM phase (V-phase) of the 120-degree energization method, the conduction type (peak ON type) is maintained. The intermediate phase (V-phase) is switched when the upper arm and the lower arm are turned off and turned on, respectively.

FIG. 21C illustrates a case where the U-phase, the V-phase, and the W-phase transition from the PWM phase (peak ON type), the PWM phase (peak ON type), and the Low fixed phase in the two-phase modulation method to the PWM phase (peak ON type), the Low fixed phase, and the non-energization phase in the 120-degree energization method, respectively. In the PWM phase (U-phase) of the 120-degree energization method, the conduction type (peak ON type) is maintained. The intermediate phase (V-phase) is switched when the upper arm and the lower arm are turned off and turned on, respectively.

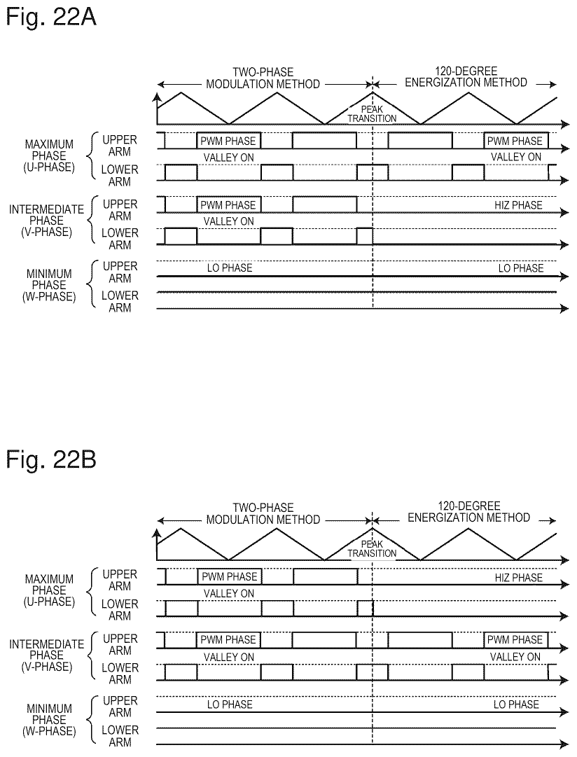

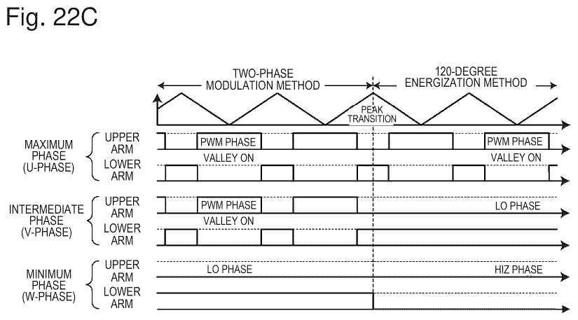

FIGS. 22A to 22C are each a diagram illustrating an example of switching in the two-phase modulation method (Min type, PWM phase valley ON type of in-phase control). FIGS. 22A to 22C illustrate examples in which the three respective combinations in the item (2) of FIG. 20 are applied.

FIG. 22A illustrates a case where the U-phase, the V-phase, and the W-phase transition from the PWM phase (valley ON type), the PWM phase (valley ON type), and the Low fixed phase in the two-phase modulation method to the PWM phase (valley ON type), the non-energization phase, and the Low fixed phase in the 120-degree energization method, respectively. In the PWM phase (U-phase) of the 120-degree energization method, the conduction type (valley ON type) is maintained. The intermediate phase (V-phase) is switched when the upper arm and the lower arm are turned off and turned on, respectively.

FIG. 22B illustrates a case where the U-phase, the V-phase, and the W-phase transition from the PWM phase (valley ON type), the PWM phase (valley ON type), and the Low fixed phase in the two-phase modulation method to the non-energization phase, the PWM phase (valley ON type), and the Low fixed phase in the 120-degree energization method, respectively. In the PWM phase (V-phase) of the 120-degree energization method, the conduction type (valley ON type) is maintained. The intermediate phase (V-phase) is switched when the upper arm and the lower arm are turned off and turned on, respectively.

FIG. 22C illustrates a case where the U-phase, the V-phase, and the W-phase transition from the PWM phase (valley ON type), the PWM phase (valley ON type), and the Low fixed phase in the two-phase modulation method to the PWM phase (valley ON type), the Low fixed phase, and the non-energization phase in the 120-degree energization method, respectively. In the PWM phase (U-phase) of the 120-degree energization method, the conduction type (valley ON type) is maintained. The intermediate phase (V-phase) is switched when the upper arm and the lower arm are turned off and turned on, respectively.

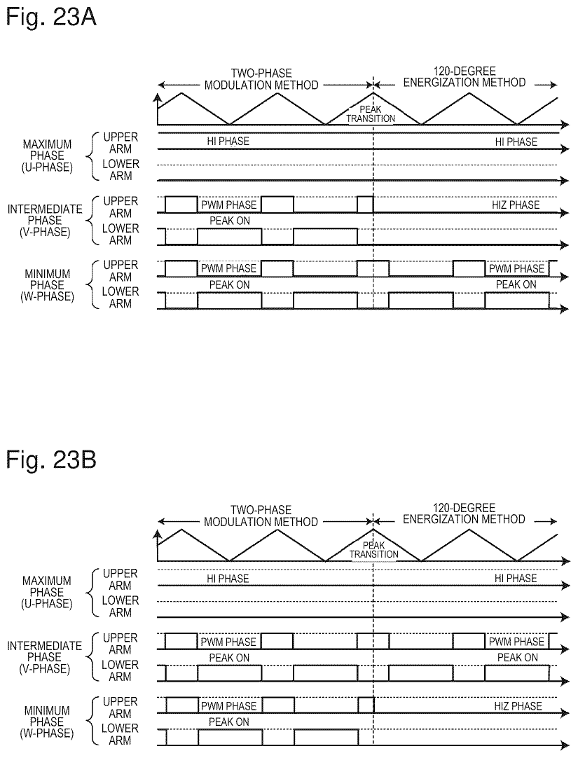

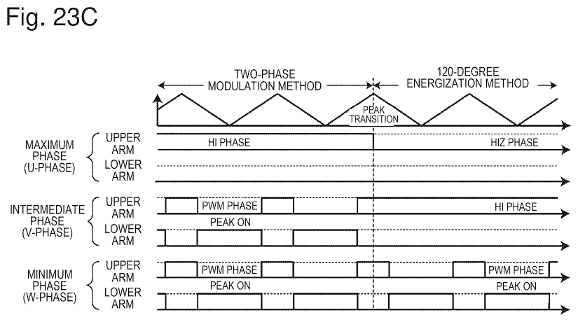

FIGS. 23A to 23C are each a diagram illustrating an example of switching in the two-phase modulation method (Max type, PWM phase peak ON type of in-phase control). FIGS. 23A to 23C illustrate examples in which the three respective combinations in the item (3) of FIG. 20 are applied.

FIG. 23A illustrates a case where the U-phase, the V-phase, and the W-phase transition from the High fixed phase, the PWM phase (peak ON type), and the PWM phase (peak ON type) in the two-phase modulation method to the High fixed phase, the non-energization phase, and the PWM phase (peak ON type) in the 120-degree energization method, respectively. In the PWM phase (W-phase) of the 120-degree energization method, the conduction type (peak ON type) is maintained. The intermediate phase (V-phase) is switched when the upper arm and the lower arm are in the ON state and the OFF state, respectively.

FIG. 23B illustrates a case where the U-phase, the V-phase, and the W-phase transition from the High fixed phase, the PWM phase (peak ON type), and the PWM phase (peak ON type) in the two-phase modulation method to the High fixed phase, the PWM phase (peak ON type), and the non-energization phase in the 120-degree energization method, respectively. In the PWM phase (V-phase) of the 120-degree energization method, the conduction type (peak ON type) is maintained. The intermediate phase (V-phase) is switched when the upper arm and the lower arm are in the ON state and the OFF state, respectively.

FIG. 23C illustrates a case where the U-phase, the V-phase, and the W-phase transition from the High fixed phase, the PWM phase (peak ON type), and the PWM phase (peak ON type) in the two-phase modulation method to the non-energization phase, the Low fixed phase, and the PWM phase (peak ON type) in the 120-degree energization method, respectively. In the PWM phase (W-phase) of the 120-degree energization method, the conduction type (peak ON type) is maintained. The intermediate phase (V-phase) is switched when the upper arm and the lower arm are in the ON state and the OFF state, respectively.

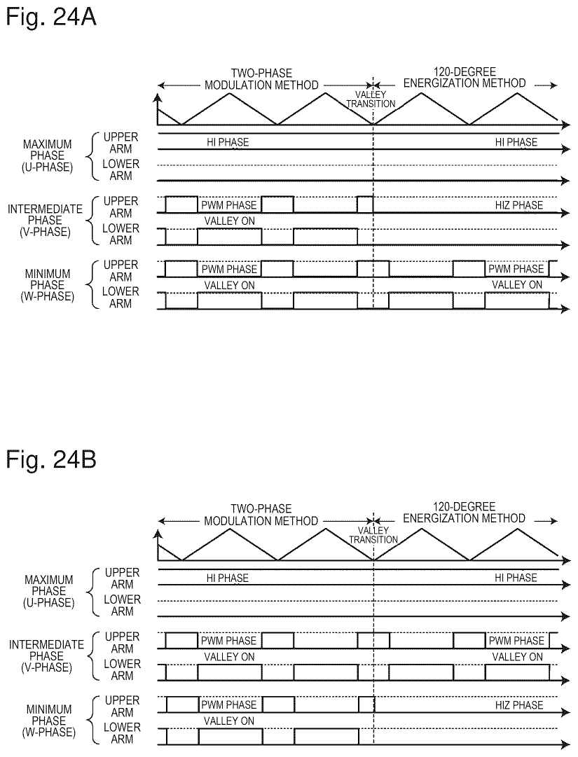

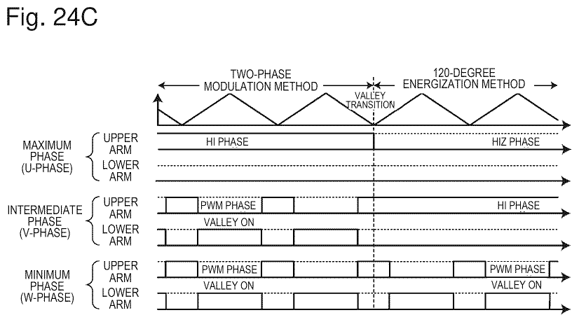

FIGS. 24A to 24C are each a diagram illustrating an example of switching in the two-phase modulation method (Max type, PWM phase valley ON type of in-phase control). FIGS. 24A to 24C illustrate examples in which the three respective combinations in the item (4) of FIG. 20 are applied.

FIG. 24A illustrates a case where the U-phase, the V-phase, and the W-phase transition from the High fixed phase, the PWM phase (valley ON type), and the PWM phase (valley ON type) in the two-phase modulation method to the High fixed phase, the non-energization phase, and the PWM phase (valley ON type) in the 120-degree energization method, respectively. In the PWM phase (W-phase) of the 120-degree energization method, the conduction type (valley ON type) is maintained. The intermediate phase (V-phase) is switched when the upper arm and the lower arm are in the ON state and the OFF state, respectively.

FIG. 24B illustrates a case where the U-phase, the V-phase, and the W-phase transition from the High fixed phase, the PWM phase (valley ON type), and the PWM phase (valley ON type) in the two-phase modulation method to the High fixed phase, the PWM phase (valley ON type), and the non-energization phase in the 120-degree energization method, respectively. In the PWM phase (V-phase) of the 120-degree energization method, the conduction type (valley ON type) is maintained. The intermediate phase (V-phase) is switched when the upper arm and the lower arm are in the ON state and the OFF state, respectively.

FIG. 24C illustrates a case where the U-phase, the V-phase, and the W-phase transition from the High fixed phase, the PWM phase (valley ON type), and the PWM phase (valley ON type) in the two-phase modulation method to the non-energization phase, the High fixed phase, and the PWM phase (valley ON type) in the 120-degree energization method, respectively. In the PWM phase (W-phase) of the 120-degree energization method, the conduction type (valley ON type) is maintained. The intermediate phase (V-phase) is switched when the upper arm and the lower arm are in the ON state and the OFF state, respectively.

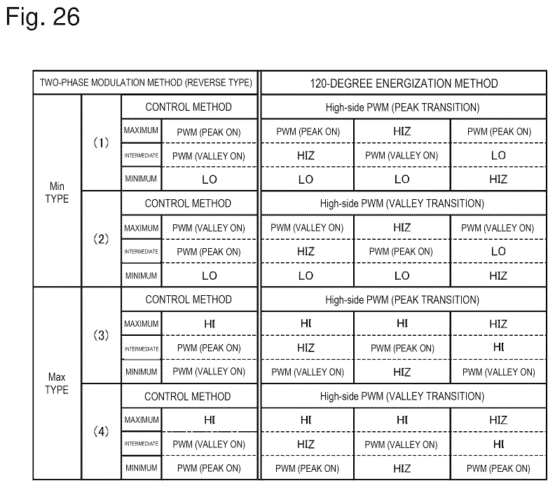

As described above, items (1) to (4) in FIG. 26 show that a short circuit does not occur in the upper and lower arms at the time of switching even when the advance control is performed.

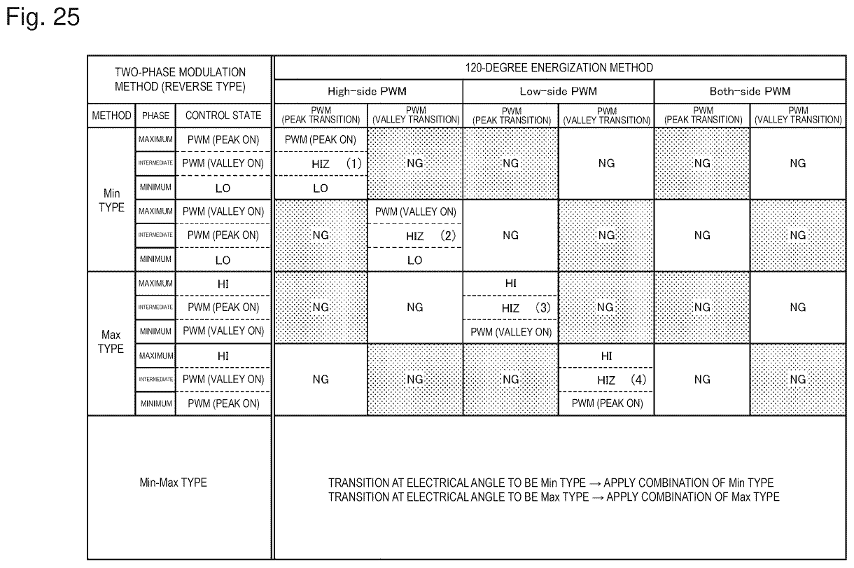

FIG. 25 is a diagram illustrating an example of a combination in which a short circuit does not occur in the upper and lower arms during transition under reverse phase control of the two-phase modulation method. As with FIG. 19, FIG. 25 illustrates an example of a combination of phase states compensated by the switching compensation unit 41 before and after switching. FIG. 25 is different from FIG. 19 in that the two-phase modulation method is under the reverse phase control.

As illustrated in FIG. 25, when the PWM phase of the maximum phase and the PWM phase of the intermediate phase are the peak ON type and the valley ON type, respectively, in the two-phase modulation method (reverse phase) of the Min type, switching to High-side PWM (peak transition) can be performed (1). At this time, the maximum phase (PWM phase), the intermediate phase (PWM phase), and the minimum phase (Low fixed phase) of the two-phase modulation method are caused to transition to the PWM phase, the non-energization phase, and the Low fixed phase of the 120-degree energization method, respectively. The switching is performed near the apex of the peak of the carrier wave.

When the PWM phase of the maximum phase and the PWM phase of the intermediate phase are the valley ON type and the peak ON type, respectively, in the two-phase modulation method (reverse phase) of the Min type, switching to High-side PWM (valley transition) can be performed (2). At this time, the maximum phase (PWM phase), the intermediate phase (PWM phase), and the minimum phase (Low fixed phase) of the two-phase modulation method are caused to transition to the PWM phase, the non-energization phase, and the Low fixed phase of the 120-degree energization method, respectively. The switching is performed near the bottom of the valley of the carrier wave.

When the PWM phase of the maximum phase and the PWM phase of the intermediate phase are the peak ON type and the valley ON type, respectively, in the two-phase modulation method (reverse phase) of the Max type, switching to Low-side PWM (peak transition) can be performed (3). At this time, the maximum phase (High fixed phase), the intermediate phase (PWM phase), and the minimum phase (PWM phase) of the two-phase modulation method are caused to transition to the High fixed phase, the non-energization phase, and the PWM phase of the 120-degree energization method, respectively. The switching is performed near the apex of the peak of the carrier wave.

When the PWM phase of the maximum phase and the PWM phase of the intermediate phase are the valley ON type and the peak ON type, respectively, in the two-phase modulation method (reverse phase) of the Max type, switching to Low-side PWM (valley transition) can be performed (4). At this time, the maximum phase (High fixed phase), the intermediate phase (PWM phase), and the minimum phase (PWM phase) of the two-phase modulation method are caused to transition to the High fixed phase, the non-energization phase, and the PWM phase of the 120-degree energization method, respectively. The switching is performed near the bottom of the valley of the carrier wave.

In the two-phase modulation method (in-phase) of the Min-Max type, a combination of the Min type is applied when switching is performed at an electrical angle to be the Min type. When switching is performed at an electrical angle to be a Max type, a combination of the Min type is applied.

These items (1) to (4) each represent a combination that allows transition and that does not cause a short circuit between the upper and lower arms even when advance control is applied.

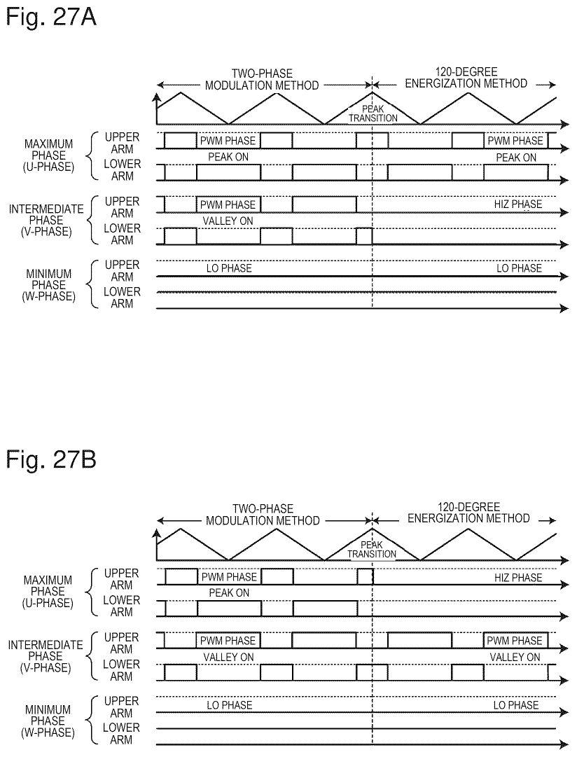

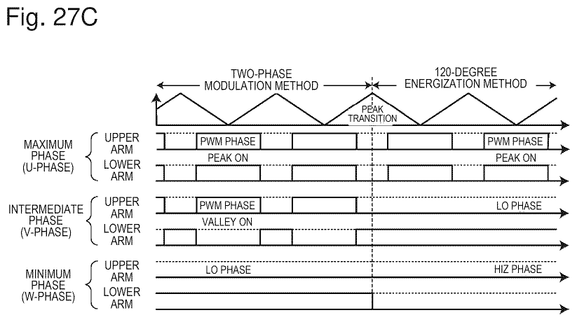

FIG. 26 is a diagram illustrating an example of a combination in which a short circuit does not occur in the upper and lower arms during transition under the reverse phase control of the two-phase modulation method. FIG. 26 is a diagram in which a combination considering the advance control is added to the combination of each of the items (1) to (4) in FIG. 25. FIG. 26 shows the 120-degree energization method with combinations including a combination at the left end in which the combination (1) and the like in FIG. 25 are described. FIG. 26 shows the 120-degree energization method with two combinations on the right side in which a phase control method is assumed to be changed by the advance control performed in the combination (1) and the like in FIG. 25. The three combinations in each of the items (1) to (4) in the drawing are verified using FIGS. 27 to 30.

FIGS. 27A to 27C are each a diagram illustrating an example of switching in the two-phase modulation method (Min type, intermediate phase peak ON type of reverse phase control). FIGS. 27A to 27C illustrate examples in which the three respective combinations in the item (1) of FIG. 26 are applied.

FIG. 27A illustrates a case where the U-phase, the V-phase, and the W-phase transition from the PWM phase (peak ON type), the PWM phase (valley ON type), and the Low fixed phase in the two-phase modulation method to the PWM phase (peak ON type), the non-energization phase, and the Low fixed phase in the 120-degree energization method, respectively. In the PWM phase (U-phase) of the 120-degree energization method, the conduction type (peak ON type) is maintained. The intermediate phase (V-phase) is switched when the upper arm and the lower arm are turned off and turned on, respectively.

FIG. 27B illustrates a case where the U-phase, the V-phase, and the W-phase transition from the PWM phase (peak ON type), the PWM phase (valley ON type), and the Low fixed phase in the two-phase modulation method to the non-energization phase, the PWM phase (valley ON type), and the Low fixed phase in the 120-degree energization method, respectively. In the PWM phase (V-phase) of the 120-degree energization method, the conduction type (valley ON type) is maintained. The intermediate phase (V-phase) is switched when the upper arm and the lower arm are turned off and turned on, respectively.

FIG. 27C illustrates a case where the U-phase, the V-phase, and the W-phase transition from the PWM phase (peak ON type), the PWM phase (valley ON type), and the Low fixed phase in the two-phase modulation method to the PWM phase (peak ON type), the Low fixed phase, and the non-energization phase in the 120-degree energization method, respectively. In the PWM phase (U-phase) of the 120-degree energization method, the conduction type (peak ON type) is maintained. The intermediate phase (V-phase) is switched when the upper arm and the lower arm are turned off and turned on, respectively.

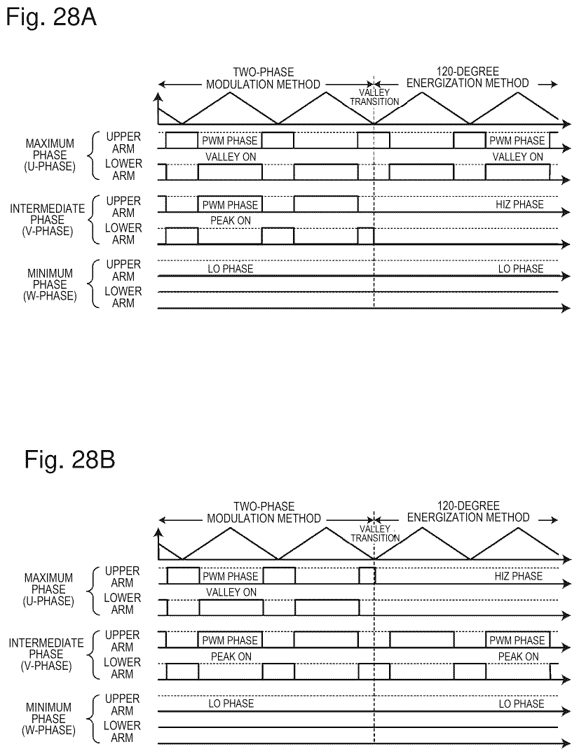

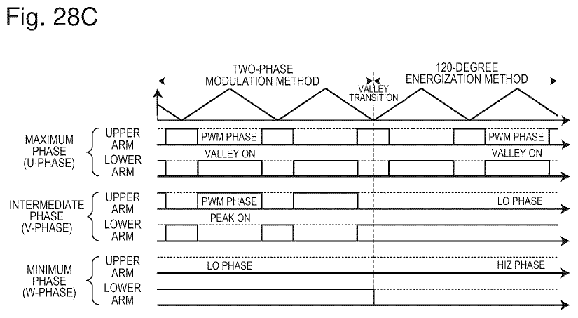

FIGS. 28A to 28C are each a diagram illustrating an example of switching in the two-phase modulation method (Min type, intermediate phase peak ON type of reverse phase control). FIGS. 28A to 28C illustrate examples in which the three respective combinations in the item (2) of FIG. 26 are applied.

FIG. 28A illustrates a case where the U-phase, the V-phase, and the W-phase transition from the PWM phase (valley ON type), the PWM phase (peak ON type), and the Low fixed phase in the two-phase modulation method to the PWM phase (valley ON type), the non-energization phase, and the Low fixed phase in the 120-degree energization method, respectively. In the PWM phase (U-phase) of the 120-degree energization method, the conduction type (valley ON type) is maintained. The intermediate phase (V-phase) is switched when the upper arm and the lower arm are turned off and turned on, respectively.

FIG. 28B illustrates a case where the U-phase, the V-phase, and the W-phase transition from the PWM phase (valley ON type), the PWM phase (peak ON type), and the Low fixed phase in the two-phase modulation method to the non-energization phase, the PWM phase (peak ON type), and the Low fixed phase in the 120-degree energization method, respectively. In the PWM phase (V-phase) of the 120-degree energization method, the conduction type (peak ON type) is maintained. The intermediate phase (V-phase) is switched when the upper arm and the lower arm are turned off and turned on, respectively.

FIG. 28C illustrates a case where the U-phase, the V-phase, and the W-phase transition from the PWM phase (valley ON type), the PWM phase (peak ON type), and the Low fixed phase in the two-phase modulation method to the PWM phase (valley ON type), the Low fixed phase, and the non-energization phase in the 120-degree energization method, respectively. In the PWM phase (U-phase) of the 120-degree energization method, the conduction type (valley ON type) is maintained. The intermediate phase (V-phase) is switched when the upper arm and the lower arm are turned off and turned on, respectively.

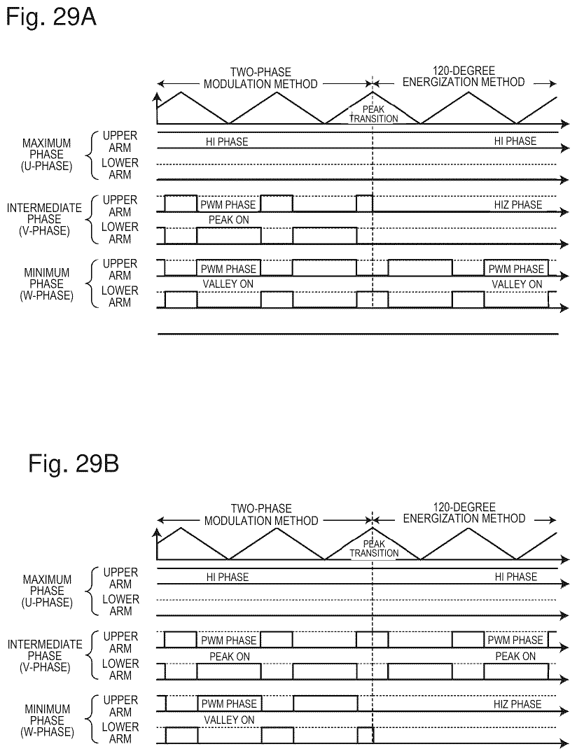

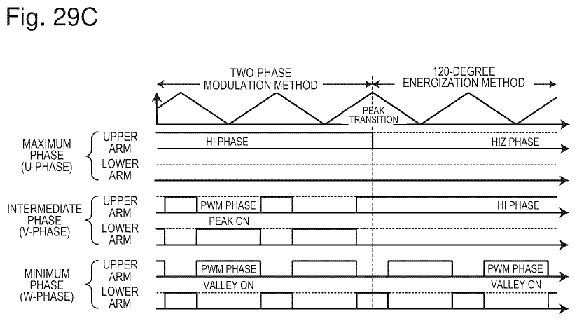

FIGS. 29A to 29C are each a diagram illustrating an example of switching in the two-phase modulation method (Max type, intermediate phase peak ON type of reverse phase control). FIGS. 29A to 29C illustrate examples in which the three respective combinations in the item (3) of FIG. 26 are applied.

FIG. 29A illustrates a case where the U-phase, the V-phase, and the W-phase transition from the High fixed phase, the PWM phase (peak ON type), and the PWM phase (valley ON type) in the two-phase modulation method to the High fixed phase, the non-energization phase, and the PWM phase (valley ON type) in the 120-degree energization method, respectively. In the PWM phase (W-phase) of the 120-degree energization method, the conduction type (valley ON type) is maintained. The intermediate phase (V-phase) is switched when the upper arm and the lower arm are in the ON state and the OFF state, respectively.

FIG. 29B illustrates a case where the U-phase, the V-phase, and the W-phase transition from the High fixed phase, the PWM phase (peak ON type), and the PWM phase (valley ON type) in the two-phase modulation method to the High fixed phase, the PWM phase (peak ON type), and the non-energization phase in the 120-degree energization method, respectively. In the PWM phase (V-phase) of the 120-degree energization method, the conduction type (peak ON type) is maintained. The intermediate phase (V-phase) is switched when the upper arm and the lower arm are in the ON state and the OFF state, respectively.

FIG. 29C illustrates a case where the U-phase, the V-phase, and the W-phase transition from the High fixed phase, the PWM phase (peak ON type), and the PWM phase (valley ON type) in the two-phase modulation method to the non-energization phase, the HI fixed phase, and the PWM phase (valley ON type) in the 120-degree energization method, respectively. In the PWM phase (W-phase) of the 120-degree energization method, the conduction type (valley ON type) is maintained. The intermediate phase (V-phase) is switched when the upper arm and the lower arm are in the ON state and the OFF state, respectively.

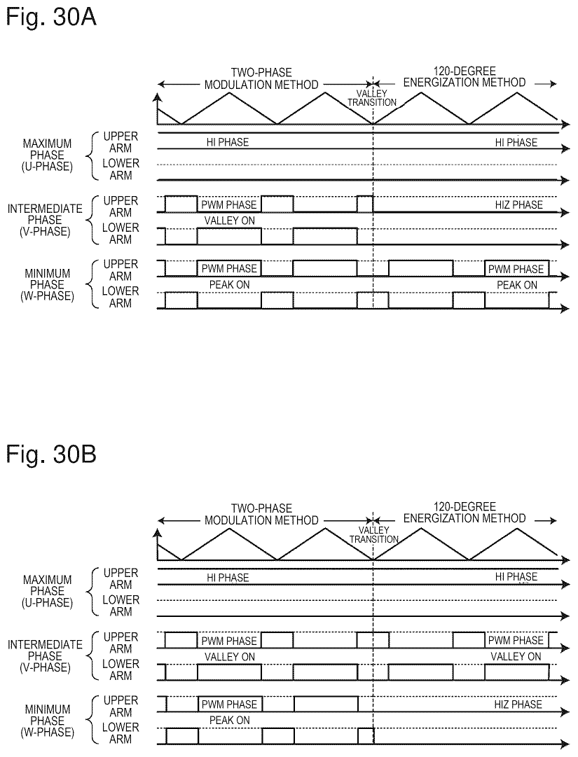

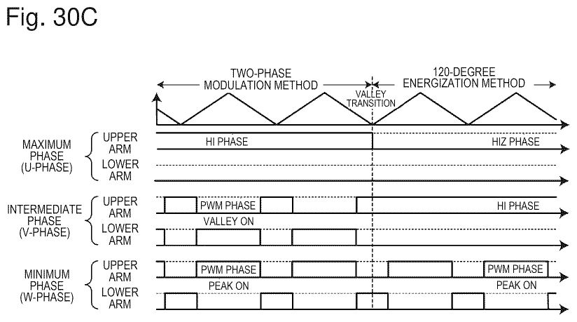

FIGS. 30A to 30C are each a diagram illustrating an example of switching in the two-phase modulation method (Max type, intermediate phase valley ON type of reverse phase control). FIGS. 30A to 30C illustrate examples in which the three respective combinations in the item (4) of FIG. 26 are applied.

FIG. 30A illustrates a case where the U-phase, the V-phase, and the W-phase transition from the High fixed phase, the PWM phase (valley ON type), and the PWM phase (peak ON type) in the two-phase modulation method to the High fixed phase, the non-energization phase, and the PWM phase (peak ON type) in the 120-degree energization method, respectively. In the PWM phase (W-phase) of the 120-degree energization method, the conduction type (peak ON type) is maintained. The intermediate phase (V-phase) is switched when the upper arm and the lower arm are in the ON state and the OFF state, respectively.

FIG. 30B illustrates a case where the U-phase, the V-phase, and the W-phase transition from the High fixed phase, the PWM phase (valley ON type), and the PWM phase (peak ON type) in the two-phase modulation method to the High fixed phase, the PWM phase (valley ON type), and the non-energization phase in the 120-degree energization method, respectively. In the PWM phase (V-phase) of the 120-degree energization method, the conduction type (valley ON type) is maintained. The intermediate phase (V-phase) is switched when the upper arm and the lower arm are in the ON state and the OFF state, respectively.

FIG. 30C illustrates a case where the U-phase, the V-phase, and the W-phase transition from the High fixed phase, the PWM phase (valley ON type), and the PWM phase (peak ON type) in the two-phase modulation method to the non-energization phase, the High fixed phase, and the PWM phase (peak ON type) in the 120-degree energization method, respectively. In the PWM phase (W-phase) of the 120-degree energization method, the conduction type (peak ON type) is maintained. The intermediate phase (V-phase) is switched when the upper arm and the lower arm are in the ON state and the OFF state, respectively.

As described above, items (1) to (4) in FIG. 26 show that a short circuit does not occur in the upper and lower arms at the time of switching even when the advance control is performed.

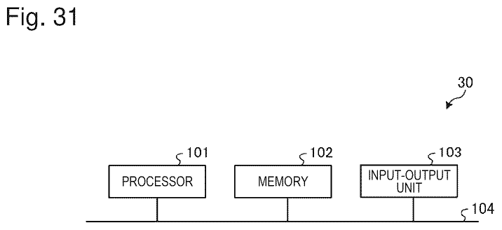

FIG. 31 is a diagram illustrating an example of a hardware configuration of the controller 30 of the motor control device 1 according to the embodiment. As illustrated in FIG. 31, the controller 30 includes a computer including a processor 101, a memory 102, an input-output unit 103, and a bus 104. The processor 101, the memory 102, and the input-output unit 103 can mutually transmit and receive information through the bus 104.

The processor 101 executes a function of the controller 30 by reading and executing a motor control program stored in the memory 102. The processor 101 is an example of a processing circuit, and includes one or more of a central processing unit (CPU), a digital signal processor (DSP), and a system large scale integration (LSI), for example.

The memory 102 includes one or more of a random access memory (RAM), a read only memory (ROM), a flash memory, an erasable programmable read only memory (EPROM), and an electrically erasable programmable read only memory (EEPROM being a registered trademark). The input-output unit 103 includes an AD converter, a DA converter, and an input-output port, for example.

The motor control device 1 may include a data reading unit that reads a motor control program from a recording medium on which the motor control program readable by a computer is recorded. The processor 101 can acquire the motor control program recorded in the recording medium from the data reading unit by controlling the data reading unit and store the acquired motor control program in the memory 102. The recording medium includes one or more of a nonvolatile or volatile semiconductor memory, a magnetic disk, a flexible memory, an optical disk, a compact disc, and a digital versatile disc (DVD), for example.

The motor control device 1 may include also a communication unit that receives the motor control program from a server through a network. This configuration enables the processor 101 to acquire the motor control program from the server through the communication unit and store the acquired motor control program in the memory 102.

The controller 30 may include an integrated circuit such as an application specific integrated circuit (ASIC) and a field programmable gate array (FPGA).

As described above, when the two-phase modulation method is switched to the 120-degree energization method, the motor control device 1 of the present disclosure performs control to cause the upper arm and the lower arm in the two energization phases of the 120-degree energization method to be identical in an ON-OFF state before and after the switching. Consequently, a short circuit between the upper and lower arms in the inverter circuit can be prevented even when there is no dead time.

Although each of the embodiments of the present disclosure have been described above, the technical scope of the present disclosure is not limited directly to each of the embodiments described above, and various modifications can be made without departing from the gist of the present disclosure. Components throughout embodiments different from each other and modifications may be appropriately combined.

The series of processing by each device described herein may be implemented using any of software, hardware, and a combination of software and hardware. Programs constituting the software are preliminarily stored in a storage medium (non-transitory medium) provided inside or outside each device, for example. Then, each program is read into the RAM when a computer executes the program, and is executed by a processor such as a CPU, for example.

The processing described herein using the flowchart and the sequence diagram may not necessarily be executed in the illustrated order. Some processing steps may be performed in parallel. Additional processing steps also may be employed, and some processing steps may be eliminated.

The motor control device 1 includes the inverter circuit 10, the conduction controller 36, and the determination unit 34. The inverter circuit 10 includes the upper arm 11 and the lower arm 12 for each of the three phases. The conduction controller 36 controls conduction of the upper arm 11 and the lower arm 12 of each of the three phases in the inverter circuit 10. The determination unit 34 determines switching from the two-phase modulation method in which two phases of the three phases serve as the PWM phases that are PWM-controlled and the remaining one phase serves as the fixed phase in which any one of the upper arm 11 and the lower arm 12 is always turned on to the 120-degree energization method in which two phases of the three phases serve as the energization phases and the remaining one phase serves as the non-energization phase. The conduction controller 36 includes a switching compensation unit that causes the upper arm 11 and the lower arm 12 in each of the two energization phases to be identical in an ON-OFF state before and after switching from the two-phase modulation method to the 120-degree energization method, the switching being determined by the determination unit 34. This configuration enables the motor control device 1 to suppress a short circuit between the upper arm 11 and the lower arm 12 in the inverter circuit 10 at the time of switching from the two-phase modulation method to the 120-degree energization method.

The conduction controller 36 allows the first conduction type and the second conduction type to be selectively used, the first conduction type and the second conduction type being different from each other in a phase of an energization waveform for turning on and off the upper arm 11 of each of the PWM phases. The energization waveform of one conduction type of the first conduction type and the second conduction type has an ON period with the center located in an OFF period of the energization waveform of the other conduction type. The conduction controller 36 performs control of setting one energization phase of the two energization phases to the PWM phase and the other energization phase to the fixed phase as control of the 120-degree energization method while switching a combination of the energization phase and the non-energization phase in the three phases every 60 degrees. The switching compensation unit may set the conduction type of the PWM phase of the two energization phases to the conduction type of the corresponding PWM phase of the two-phase modulation method before and after the switching. This configuration enables the motor control device 1 to suppress a short circuit between the upper arm 11 and the lower arm 12 in the inverter circuit 10 at the time of switching from the two-phase modulation method to the 120-degree energization method.

The conduction controller 36 may fix the lower arm 12 to an ON state in the fixed phase of the two-phase modulation method, and fix the lower arm 12 to the ON state in the fixed phase of the 120-degree energization method. The switching compensation unit may set switching timing in a period in which the upper arm 11 and the lower arm 12 of an intermediate phase among a maximum phase with a duty ratio in a maximum level, the intermediate phase with the duty ratio in a middle level, and a minimum phase with the duty ratio in a minimum level are in the OFF state and the ON state, respectively, the duty ratio being a ratio of a period in which the upper arm 11 is in the ON state in a control period of the PWM phase in the three phases of the two-phase modulation method. This configuration enables the motor control device 1 to suppress a short circuit between the upper arm 11 and the lower arm 12 in the inverter circuit 10 at the time of switching from the two-phase modulation method of the Min type to the 120-degree energization method.

The switching compensation unit may also configure setting in which the maximum phase, the intermediate phase, and the minimum phase in the two-phase modulation method corresponds to the PWM phase, the non-energization phase, and the fixed phase in the 120-degree energization method, respectively.

The switching compensation unit may also configure setting in which the maximum phase, the intermediate phase, and the minimum phase in the two-phase modulation method correspond to the non-energization phase, the PWM phase, and the fixed phase in the 120-degree energization method, respectively.

The switching compensation unit also configure setting in which the maximum phase, the intermediate phase, and the minimum phase in the two-phase modulation method correspond to the PWM phase, the fixed phase, and the non-energization phase in the 120-degree energization method, respectively.

The conduction controller 36 may also fix the upper arm 11 to an ON state in the fixed phase of the two-phase modulation method, and fix the upper arm 11 to the ON state in the fixed phase of the 120-degree energization method. The switching compensation unit may set switching timing in a period in which the upper arm 11 and the lower arm 12 of an intermediate phase among a maximum phase with a duty ratio in a maximum level, the intermediate phase with the duty ratio in a middle level, and a minimum phase with the duty ratio in a minimum level are in the ON state and the OFF state, respectively, the duty ratio being a ratio of a period in which the upper arm 11 is in the ON state in a control period of the PWM phase in the three phases of the two-phase modulation method. This configuration enables the motor control device 1 to suppress a short circuit between the upper arm 11 and the lower arm 12 in the inverter circuit 10 at the time of switching from the two-phase modulation method of the Max type to the 120-degree energization method.

The switching compensation unit may also configure setting in which the maximum phase, the intermediate phase, and the minimum phase in the two-phase modulation method corresponds to the fixed phase, the non-energization phase, and the PWM phase in the 120-degree energization method, respectively.

The switching compensation unit also configure setting in which the maximum phase, the intermediate phase, and the minimum phase in the two-phase modulation method correspond to the fixed phase, the PWM phase, and the non-energization phase in the 120-degree energization method, respectively.

The switching compensation unit also configure setting in which the maximum phase, the intermediate phase, and the minimum phase in the two-phase modulation method correspond to the non-energization phase, the fixed phase, and the PWM phase in the 120-degree energization method, respectively.

The conduction controller 36 may perform control of the two-phase modulation method while switching between control of a first control type that fixes the lower arm 12 of the fixed phase to the ON state and control of a second control type that fixes the upper arm 11 of the fixed phase to the ON state every 60 degrees and switching the combination of the PWM phase and the fixed phase in the three phases every 60 degrees. The switching compensation unit may perform processing of causing the conduction controller 36 to apply a control method of fixing the lower arm 12 to the ON state in the fixed phase of the 120-degree energization method when the two-phase modulation method of the first control type is switched to the 120-degree energization method, and set switching timing in a period in which the upper arm 11 and the lower arm 12 of an intermediate phase are in the OFF state and the ON state, respectively, the intermediate phase having a duty ratio in a middle level, the duty ratio being a ratio of a period in which the upper arm 11 is in the ON state in a control period of the PWM phase in the three phases in the two-phase modulation method. The switching compensation unit may perform processing of causing the conduction controller 36 to apply a control method of fixing the upper arm 11 to the ON state in the fixed phase of the 120-degree energization method when the two-phase modulation method of the second control type is switched to the 120-degree energization method, and set switching timing in a period in which the upper arm 11 and the lower arm 12 of the intermediate phase in the three phases in the two-phase modulation method are in the ON state and the OFF state, respectively. This configuration enables the motor control device 1 to suppress a short circuit between the upper arm 11 and the lower arm 12 in the inverter circuit 10 at the time of switching from the two-phase modulation method of the Min-Max type to the 120-degree energization method.

A motor control program causes a computer to execute procedures including: a conduction control procedure for controlling conduction of an upper arm 11 and a lower arm 12 of each phase of three phases in an inverter circuit 10 including the upper arm 11 and the lower arm 12 for each phase of the three phases; a determination procedure for determining switching from a two-phase modulation method in which two phases of the three phases serve as PWM phases thar are PWM-controlled and remaining one phase serves as a fixed phase in which any one of the upper arm 11 and the lower arm 12 is always turned on to a 120-degree energization method in which two phases of the three phases serve as energization phases and remaining one phase serves as a non-energization phase; and a switching compensation procedure for causing the upper arm 11 and the lower arm 12 in each of the two energization phases to be identical in an ON-OFF state before and after switching from the two-phase modulation method to the 120-degree energization method, the switching being determined by the determination procedure. Consequently, a short circuit between the upper arm 11 and the lower arm 12 in the inverter circuit 10 can be suppressed at the time of switching from the two-phase modulation method to the 120-degree energization method.

A motor control method includes: a conduction control step of controlling conduction of an upper arm 11 and a lower arm 12 of each phase of three phases in an inverter circuit 10 including the upper arm 11 and the lower arm 12 for each phase of the three phases; a determination step of determining switching from a two-phase modulation method in which two phases of the three phases serve as PWM phases thar are PWM-controlled and remaining one phase serves as a fixed phase in which any one of the upper arm 11 and the lower arm 12 is always turned on to a 120-degree energization method in which two phases of the three phases serve as energization phases and remaining one phase serves as a non-energization phase; and a switching compensation step of causing the upper arm 11 and the lower arm 12 in each of the two energization phases to be identical in an ON-OFF state before and after switching from the two-phase modulation method to the 120-degree energization method, the switching being determined by the determination step. Consequently, a short circuit between the upper arm 11 and the lower arm 12 in the inverter circuit 10 can be suppressed at the time of switching from the two-phase modulation method to the 120-degree energization method.

The effects described herein are merely examples and are not limited, and other effects may be provided.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor control device comprising:
an inverter circuit including an upper arm and a lower arm for each of three phases;
a conduction controller that controls conduction of the upper arm and the lower arm of each of the three phases in the inverter circuit; and
a determination unit that determines switching from a two-phase modulation method in which two phases of the three phases serve as PWM phases that are PWM-controlled and remaining one phase serves as a fixed phase in which any one of the upper arm and the lower arm is always turned on to a 120-degree energization method in which two phases of the three phases serve as energization phases and remaining one phase serves as a non-energization phase,
the conduction controller including:
a switching compensation unit that causes the upper arm and the lower arm in each of the two energization phases to be identical in an ON-OFF state before and after switching from the two-phase modulation method to the 120-degree energization method, the switching being determined by the determination unit.

2. The motor control device according to claim 1, wherein
the conduction controller allows a first conduction type and a second conduction type to be selectively used, the first conduction type and the second conduction type being different from each other in a phase of an energization waveform for turning on and off the upper arm of each of the PWM phases,
the energization waveform of one conduction type of the first conduction type and the second conduction type has an ON period with a center located in an OFF period of the energization waveform of another conduction type,
the conduction controller performs control of setting one energization phase of the two energization phases to the PWM phase and another energization phase to the fixed phase as control of the 120-degree energization method while switching a combination of the energization phase and the non-energization phase in the three phases every 60 degrees, and
the switching compensation unit sets the conduction type of the PWM phase of the two energization phases to the conduction type of the corresponding PWM phase of the two-phase modulation method before and after the switching.

3. The motor control device according to claim 2, wherein
the conduction controller
fixes the lower arm to an ON state in the fixed phase of the two-phase modulation method, and
fixes the lower arm to the ON state in the fixed phase of the 120-degree energization method, and
the switching compensation unit sets switching timing in a period in which the upper arm and the lower arm of an intermediate phase among a maximum phase with a duty ratio in a maximum level, the intermediate phase with the duty ratio in a middle level, and a minimum phase with the duty ratio in a minimum level are in the OFF state and the ON state, respectively, the duty ratio being a ratio of a period in which the upper arm is in the ON state in a control period of the PWM phase in the three phases of the two-phase modulation method.

4. The motor control device according to claim 3, wherein the switching compensation unit configures setting in which the maximum phase, the intermediate phase, and the minimum phase in the two-phase modulation method corresponds to the PWM phase, the non-energization phase, and the fixed phase in the 120-degree energization method, respectively.

5. The motor control device according to claim 3, wherein the switching compensation unit configures setting in which the maximum phase, the intermediate phase, and the minimum phase in the two-phase modulation method correspond to the non-energization phase, the PWM phase, and the fixed phase in the 120-degree energization method, respectively.

6. The motor control device according to claim 3, wherein the switching compensation unit configures setting in which the maximum phase, the intermediate phase, and the minimum phase in the two-phase modulation method correspond to the PWM phase, the fixed phase, and the non-energization phase in the 120-degree energization method, respectively.

7. The motor control device according to claim 2, wherein
the conduction controller
fixes the upper arm to an ON state in the fixed phase of the two-phase modulation method, and
fixes the upper arm to the ON state in the fixed phase of the 120-degree energization method, and
the switching compensation unit sets switching timing in a period in which the upper arm and the lower arm of an intermediate phase among a maximum phase with a duty ratio in a maximum level, the intermediate phase with the duty ratio in a middle level, and a minimum phase with the duty ratio in a minimum level are in the ON state and the OFF state, respectively, the duty ratio being a ratio of a period in which the upper arm is in the ON state in a control period of the PWM phase in the three phases of the two-phase modulation method.

8. The motor control device according to claim 7, wherein the switching compensation unit configures setting in which the maximum phase, the intermediate phase, and the minimum phase in the two-phase modulation method corresponds to the fixed phase, the non-energization phase, and the PWM phase in the 120-degree energization method, respectively.

9. The motor control device according to claim 7, wherein the switching compensation unit configures setting in which the maximum phase, the intermediate phase, and the minimum phase in the two-phase modulation method correspond to the fixed phase, the PWM phase, and the non-energization phase in the 120-degree energization method, respectively.

10. The motor control device according to claim 7, wherein the switching compensation unit configures setting in which the maximum phase, the intermediate phase, and the minimum phase in the two-phase modulation method correspond to the non-energization phase, the fixed phase, and the PWM phase in the 120-degree energization method, respectively.

11. The motor control device according to claim 2, wherein
the conduction controller performs control of the two-phase modulation method while switching between control of a first control type that fixes the lower arm of the fixed phase to the ON state and control of a second control type that fixes the upper arm of the fixed phase to the ON state every 60 degrees and switching a combination of the PWM phase and the fixed phase in the three phases every 60 degrees,
the switching compensation unit
performs processing of causing the conduction controller to apply a control method of fixing the lower arm to the ON state in the fixed phase of the 120-degree energization method when the two-phase modulation method of the first control type is switched to the 120-degree energization method, and
sets switching timing in a period in which the upper arm and the lower arm of an intermediate phase are in the OFF state and the ON state, respectively, the intermediate phase having a duty ratio in a middle level, the duty ratio being a ratio of a period in which the upper arm is in the ON state in a control period of the PWM phase in the three phases in the two-phase modulation method, and
the switching compensation unit
performs processing of causing the conduction controller to apply a control method of fixing the upper arm to the ON state in the fixed phase of the 120-degree energization method when the two-phase modulation method of the second control type is switched to the 120-degree energization method, and
sets switching timing in a period in which the upper arm and the lower arm of the intermediate phase in the three phases in the two-phase modulation method are in the ON state and the OFF state, respectively.

12. A motor module comprising:
the motor control device according to claim 1; and
a motor controlled by the motor control device.

13. A motor control program that causes a computer to execute procedures comprising:
a conduction control procedure for controlling conduction of an upper arm and a lower arm of each phase of three phases in an inverter circuit including the upper arm and the lower arm for each phase of the three phases;
a determination procedure for determining switching from a two-phase modulation method in which two phases of the three phases serve as PWM phases thar are PWM-controlled and remaining one phase serves as a fixed phase in which any one of the upper arm and the lower arm is always turned on to a 120-degree energization method in which two phases of the three phases serve as energization phases and remaining one phase serves as a non-energization phase; and
a switching compensation procedure for causing the upper arm and the lower arm in each of the two energization phases to be identical in an ON-OFF state before and after switching from the two-phase modulation method to the 120-degree energization method, the switching being determined by the determination procedure.

14. A motor control method comprising:
a conduction control step of controlling conduction of an upper arm and a lower arm of each phase of three phases in an inverter circuit including the upper arm and the lower arm for each phase of the three phases;
a determination step of determining switching from a two-phase modulation method in which two phases of the three phases serve as PWM phases thar are PWM-controlled and remaining one phase serves as a fixed phase in which any one of the upper arm and the lower arm is always turned on to a 120-degree energization method in which two phases of the three phases serve as energization phases and remaining one phase serves as a non-energization phase; and
a switching compensation step of causing the upper arm and the lower arm in each of the two energization phases to be identical in an ON-OFF state before and after switching from the two-phase modulation method to the 120-degree energization method, the switching being determined by the determination step.
